(19) United States
(12) Patent Application Publication
(10) Pub. No.: US 2015/0295631 A1
(43) Pub. Date: Oct. 15, 2015

(54) COMMUNICATION SYSTEM, COMMUNICATION METHOD, TRANSMISSION METHOD FOR MOBILE STATION, MOBILE STATION DEVICE, AND BASE STATION DEVICE

(71) Applicant: Sharp Kabushiki Kaisha, Osaka-shi, Osaka (JP)

(72) Inventors: Takashi Yoshimoto, Osaka-shi (JP); Kozue Yokomakura, Osaka-shi (JP); Ryota Yamada, Osaka-shi (JP); Katsuya Kato, Osaka-shi (JP); Minoru Kubota, Osaka-shi (JP)

(21) Appl. No.: 14/414,142

(22) PCT Filed: Jul. 12, 2013
(86) PCT No.: PCT/JP2013/069101

§ 371 Date: Jan. 12, 2015

(30) Foreign Application Priority Data
Jul. 13, 2012 (JP) 2012-157407

(51) Int. Cl. H04B 7/06; H04L 27/26; H04B 7/02; H04W 72/04

(52) U.S. Cl. CPC H04B 7/0626; H04W 72/0413; H04L 27/2601; H04B 7/024; H04B 7/0647; H04W 88/02

(57) ABSTRACT

It is possible to effectively perform feedback in a communication system in which base station devices cooperatively communicate. A feedback information generation unit 208 has a function of adjusting the amount of information used for representing a channel estimated value which is output from a channel estimation unit 206, depending on each base station device. In other words, among a feedback information amount used for representing a channel estimated value between the mobile station device and the base station device connected to the mobile station device, and a feedback information amount used for representing a channel estimated value between the mobile station device and a base station device other than the base station device connected to the mobile station device, the feedback information amount used for representing one type of channel estimated value is adjusted so as to be less than the feedback information amount used for representing the other type of channel estimated value.

### TECHNICAL FIELD

The present invention relates to a communication system, a communication method, a transmission method for a mobile station, a mobile station device, and a base station device, in which base station devices cooperatively communicate in wireless communication.

### BACKGROUND ART

In a wireless communication system such as a wireless LAN and a mobile phone, a plurality of base station devices (eNB: eNodeB) are allocated in a cellular configuration, because of expansion of communication areas. A range (communication service area) at which each base station device is connectable with a mobile station device (UE: User Equipment) is referred to as a cell. Further, the cell is divided into several ranges. The range obtained after the division is referred to as a sector. Each base station device manages connection with the mobile station device, which is conducted in the cell or sector serving as a unit.

In such a wireless communication system, interference occurs between cells which are configured with respective base station devices or sectors (hereinafter, referred to as inter-cell interference). Therefore, there is a problem of a decrease in throughput of an entire cell or user throughput of a mobile station device located at the end of the cell.

As means for solving such a problem, there is coordinated multiple point transmission/reception (CoMP) in which base station devices cooperatively communicate with each other (NPL 1).

FIG. 19 is a diagram illustrating an example of CoMP.

In FIG. 19, a base station device 1000-1 and a base station device 1000-2 constituting a cell respectively have cell ranges 1000-1a and 1000-2a. Mobile station devices 2000-1 and 2000-2 are respectively connected to the base station device 1000-1 and the base station device 1000-2.

Then, the base station device 1000-1 transmits a signal that has directivity to the mobile station device 2000-1 and that is multiplied by a weight coefficient so as not to interfere with the mobile station device 2000-2, to the mobile station device 2000-1 (r11-1). Further, the base station device 1000-2 transmits a signal that has directivity to the mobile station device 2000-2 and that is multiplied by a transmission weight so as not to interfere with the mobile station device 2000-1, to the mobile station device 2000-2 (r11-1). This enables suppressing the inter-cell interference. The multiplication by the transmission weight is referred to as pre-coding.

Here, in order to calculate the transmission weight coefficient, channel information between the base station device and the mobile station device is required.

For example, in a frequency division duplex, the mobile station device estimates a channel, by using a pilot signal for channel (propagation channel) measurement (a reference signal in LTE) transmitted by the base station device. Then, the mobile station device feeds back the channel information to the base station device.

In FIG. 19, if a channel between a mobile station device 1000-i and a base station device 1000-j is assumed as Hᵢⱼ, the mobile station device 2000-1 estimates H₁₁ and H₁₂, and feeds back the channels to the base station device 1000-1 (r11-2). Further, the mobile station device 2000-2 estimates H₂₁ and H₂₂, and feeds back the channels to the base station device 1000-2 (r22-2). The specific method of such feedback is disclosed in PTL 1.

### CITATION LIST

### Patent Literature

PTL 1: International Publication No. 2011/158943 Non Patent Literature

NPL 1: 3rd Generation Partnership Project: Technical Specification Group Radio Access Network: Further Advancements for E-UTRA Physical Layer Aspects (Release 9), 3GPP TR 36.814 V9.0.0 (2010-03), March, 2010, URL: http://www.3gpp.org/ftp/Specs/html-info/36814.htm

### SUMMARY OF INVENTION

### Technical Problem

However, in recent years, with an increase in traffic amount due to an increase in a service of a great volume, an increase in a transmission rate, an increase in a system throughput, and dispersion of traffic are required in a wireless communication. As means of satisfying these requirements, it has been proposed to arrange a plurality of base station devices such that part or all of the range of the macro-cell that is formed by a master base station device (a macro base station) overlaps the range of a cell of small power base station (a picocell base station, a femtocell base station, and the like) having smaller maximum transmission power than that of the macro base station (a heterogeneous network, NPL 1). In the heterogeneous network, the mobile station device is connected to the base station device having a greatest transmission power and signal to interference and noise ratio (SINR), among these base station devices, such that an increase in the transmission rate, an increase in the system throughput, and the dispersion of traffic are expected.

Then, in a heterogeneous network, since base station devices having different values of transmission power are complicatedly allocated, the number of interference sources of inter-cell interference increases. Therefore, when applying the CoMP in the heterogeneous network, there is a problem of an increase in the amount of feedback of the channel information. Further, if the amount of feedback is limited, the inter-cell interference cannot be sufficiently suppressed.

The present invention has been made in view of such circumstances described above, and an object is to provide a communication system, a communication method, a transmission method for a mobile station, a mobile station device, and a base station device, that can effectively perform feedback in a communication system in which base station devices cooperatively communicate.

### Solution to Problem

The respective components of the communication system, the communication method, the base station device, and the mobile station device according to the embodiment of the present invention in order to solve the above problems are as follows.

According to an aspect of the present invention, it is provided a communication system which includes a plurality of base station devices and a mobile station device connected to at least one of the plurality of base station devices and in which the plurality of base station devices cooperate so as to transmit a signal to the mobile station device, in which the mobile station device includes a channel estimation unit that estimates channel information between the mobile station device and a base station device connected to the mobile station device and channel information between the mobile station device and a base station device other than the base station connected to the mobile station device; a feedback information generation unit that generates feedback information for notifying the channel information between the mobile station device and the base station device connected to the mobile station device and feedback information for notifying the channel information between the mobile station device and the base station device other than the base station connected to the mobile station device, by using the channel information estimated by the channel estimation unit; and a transmission unit that transmits the feedback information to the base station device, in which the amount of the feedback information for notifying the channel information between the mobile station device and the base station device connected to the mobile station device and the amount of the feedback information for notifying the channel information between the mobile station device and the base station device other than the base station connected to the mobile station device, which are generated in the feedback information generation unit, are different from each other, in which a certain base station device of the plurality of base station devices includes a weight coefficient calculation unit that calculates a transmission weight coefficient to be multiplied by transmission data which is transmitted from each base station device to the mobile station device connected to the base station device, by using the feedback information, and in which the plurality of base station devices each includes a pre-coding unit that multiplies the transmission data by the transmission weight coefficient.

In the communication system according an aspect of the present invention, the amount of the feedback information for notifying the channel information between the mobile station device and the base station device connected to the mobile station device may be smaller than the amount of the feedback information for notifying the channel information between the mobile station device and the base station device other than the base station connected to the mobile station device, which are generated in the feedback information generation unit.

Further, in the communication system according an aspect of the present invention, the feedback information generation unit generates the feedback information, by quantizing the channel information estimated by the channel estimation unit, and in which the number of quantization bits of feedback information for notifying the channel information between the mobile station device and the base station device connected to the mobile station device is different from the number of quantization bits of feedback information for notifying the channel information between the mobile station device and the base station device other than the base station connected to the mobile station device.

In the communication system according an aspect of the present invention, the number of quantization bits of the feedback information for notifying the channel information between the mobile station device and the base station device connected to the mobile station device may be smaller than the number of quantization bits of the feedback information for notifying the channel information between the mobile station device and the base station device other than the base station connected to the mobile station device, which are generated in the feedback information generation unit.

Further, in the communication system according an aspect of the present invention, the feedback information generation unit generates the feedback information, by compressing the channel information estimated by the channel estimation unit, and a compression rate of feedback information for notifying the channel information between the mobile station device and the base station device connected to the mobile station device is different from a compression rate of feedback information for notifying the channel information between the mobile station device and the base station device other than the base station connected to the mobile station device.

Further, the compression rate of feedback information for notifying the channel information between the mobile station device and the base station device connected to the mobile station device may be greater than the compression rate of feedback information for notifying the channel information between the mobile station device and the base station device other than the base station connected to the mobile station device, which generated in the feedback information generation unit.

Further, in the communication system according an aspect of the present invention, the mobile station device may include a control signal generation unit that generates an uplink control signal, the transmission unit may transmit the uplink control signal to the base station device, and the control signal generation unit may have a control signal format for the control signal containing the feedback information.

Further, in the communication system according an aspect of the present invention, the mobile station device may include a control signal generation unit that generates an uplink control signal, the transmission unit may transmit the uplink control signal to the base station device, and the control signal generation unit may have a control signal format containing the feedback information for notifying the channel information between the mobile station device and the base station device connected to the mobile station device and a control signal format containing the feedback information for notifying the channel information between the mobile station device and the base station device other than the base station connected to the mobile station device.

Further, the control signal format containing the feedback information for notifying the channel information between the mobile station device and the base station device connected to the mobile station device and the control signal format containing the feedback information for notifying the channel information between the mobile station device and the base station device other than the base station connected to the mobile station device may be control signal formats having different numbers of OFDM symbols.

Further, the control signal format containing the feedback information for notifying the channel information between the mobile station device and the base station device connected to the mobile station device and the control signal format containing the feedback information for notifying the channel information between the mobile station device and the base station device other than the base station connected to the mobile station device may be control signal formats having different numbers of subcarriers.

According to another aspect of the present invention, there is provided a mobile station device in a communication system which includes a plurality of base station devices and the mobile station device connected to at least one of the plurality of base station devices and in which the plurality of base station devices cooperate so as to transmit a signal to the mobile station device, including channel estimation unit that estimates channel information between the mobile station device and a base station device connected to the mobile station device and channel information between the mobile station device and a base station device other than the base station connected to the mobile station device; a feedback information generation unit that generates feedback information for notifying the channel information between the mobile station device and the base station device connected to the mobile station device and feedback information for notifying the channel information between the mobile station device and the base station device other than the base station connected to the mobile station device, by using the channel information estimated by the channel estimation unit; and a transmission unit that transmits the feedback information to the base station device, in which the amount of the feedback information for notifying the channel information between the mobile station device and the base station device connected to the mobile station device and the amount of the feedback information for notifying the channel information between the mobile station device and the base station device other than the base station connected to the mobile station device, which are generated in the feedback information generation unit, are different.

According to still another aspect of the present invention, there is provided a communication method in which a plurality of base station devices and a mobile station device connected to at least one of the plurality of base station devices are included and the plurality of base station devices cooperate so as to transmit a signal to the mobile station device, in which the mobile station device performs a channel estimation procedure of estimating channel information between the mobile station device and a base station device connected to the mobile station device and channel information between the mobile station device and a base station device other than the base station connected to the mobile station device; a feedback information generation procedure of generating feedback information for notifying the channel information between the mobile station device and the base station device connected to the mobile station device and feedback information for notifying the channel information between the mobile station device and the base station device other than the base station connected to the mobile station device, by using the channel information estimated in the channel estimation procedure; and a transmission procedure of transmitting the feedback information to the base station device, in which the amount of the feedback information for notifying the channel information between the mobile station device and the base station device connected to the mobile station device and the amount of the feedback information for notifying the channel information between the mobile station device and the base station device other than the base station connected to the mobile station device, which are generated in the feedback information generation procedure, are different, in which a certain base station device of the plurality of base station devices performs a weight coefficient calculation procedure of calculating a transmission weight coefficient to be multiplied by transmission data which is transmitted from each base station device to the mobile station device connected to the base station device, by using the feedback information, and in which the plurality of base station devices each performs a pre-coding procedure of multiplying the transmission data by the transmission weight coefficient.

According to further still another aspect of the present invention, there is provided a transmission method of a mobile station device in a communication system which includes a plurality of base station devices and the mobile station device connected to at least one of the plurality of base station devices and in which the plurality of base station devices cooperate with each other, in which the mobile station device performs a channel estimation procedure of estimating channel information between the mobile station device and a base station device connected to the mobile station device and channel information between the mobile station device and a base station device other than the base station connected to the mobile station device; a feedback information generation procedure of generating feedback information for notifying the channel information between the mobile station device and the base station device connected to the mobile station device and feedback information for notifying the channel information between the mobile station device and the base station device other than the base station connected to the mobile station device, by using the channel information estimated in the channel estimation procedure; and a transmission unit of transmitting the feedback information to the base station device, in which the amount of the feedback information for notifying the channel information between the mobile station device and the base station device connected to the mobile station device and the amount of the feedback information for notifying the channel information between the mobile station device and the base station device other than the base station connected to the mobile station device are different.

According to further still another aspect of the present invention, there is provided a base station device in a communication system which includes a plurality of base station devices and a mobile station device connected to at least one of the plurality of base station devices and in which the plurality of base station devices cooperate so as to transmit a signal to the mobile station device, in which the mobile station device includes a channel estimation unit that estimates channel information between the mobile station device and a base station device connected to the mobile station device and channel information between the mobile station device and a base station device other than the base station connected to the mobile station device; a feedback information generation unit that generates feedback information for notifying the channel information between the mobile station device and the base station device connected to the mobile station device and feedback information for notifying the channel information between the mobile station device and the base station device other than the base station connected to the mobile station device, by using the channel information estimated by the channel estimation unit; and a transmission unit that transmits the feedback information to the base station device, in which the amount of the feedback information for notifying the channel information between the mobile station device and the base station device connected to the mobile station device and the amount of the feedback information for notifying the channel information between the mobile station device and the base station device other than the base station connected to the mobile station device, which are generated in the feedback information generation unit, are different from each other, in which a certain base station device of the plurality of base station devices includes a weight coefficient calculation unit that calculates a transmission weight coefficient to be multiplied by transmission data which is transmitted from each base station device to the mobile station device connected to the base station device, by using the feedback information, and in which the plurality of base station devices each includes a pre-coding unit that multiplies the transmission data by the transmission weight coefficient.

### Advantageous Effects of Invention

According to the present invention, it is possible to achieve an excellent effect in which the mobile station device effectively can notify the mobile station device of feedback information while maintaining interference suppression effect as much as possible in the communication system in which base station devices cooperatively communicate.

### BRIEF DESCRIPTION OF DRAWINGS

FIG. 1 is a schematic diagram illustrating a cellular configuration of a communication system according to a first embodiment of the present invention.

FIG. 2 is a schematic diagram illustrating a downlink channel in the communication system according to the first embodiment of the present invention.

FIG. 3 is a schematic diagram illustrating a configuration of master base station device according to the first embodiment of the present invention.

FIG. 4 is a conceptual diagram illustrating an example of a format of a control signal that is output by a control signal generation unit.

FIG. 5 is a flowchart illustrating an example of a process in which a weight control unit calculates a transmission weight coefficient and a reception weight coefficient.

FIG. 6 is a schematic diagram illustrating a configuration of a slave base station device according to the first embodiment of the present invention.

FIG. 7 is a schematic diagram illustrating a configuration of a mobile station device according to the first embodiment of the present invention.

FIG. 8 is a diagram illustrating an aspect of a method in which a feedback information generation unit adjusts the number of quantization bits.

FIG. 9 is a diagram illustrating an example of resource mapping of a resource mapping unit in the base station device.

FIG. 10 is a sequence diagram illustrating an operation example in which the master base station device of the communication system calculates the transmission weight coefficient and the reception weight coefficient, and notifies the slave base station device and the mobile station device of the calculated coefficients.

FIG. 11 is an example of all frame formats of signals transmitted to the base station device by the mobile station device.

FIG. 12 is an example of a control signal format in a control signal placement area of an uplink frame format.

FIG. 13 is a diagram illustrating an example of a control signal format in a control signal placement area of an uplink frame format in a second embodiment of the present invention.

FIG. 14 is a diagram illustrating another example of a control signal format in a control signal placement area of an uplink frame format in the second embodiment of the present invention.

FIG. 15 is a diagram illustrating an aspect of generating feedback information from a channel estimated value by a compression process in a third embodiment of the present invention.

FIG. 16 is a schematic diagram illustrating a configuration of a feedback information generation unit according to a fourth embodiment of the present invention.

FIG. 17 is a diagram illustrating an aspect of compressing the channel information by converting it into information in a time domain.

FIG. 18 is a sequence diagram illustrating an operation example in which a master base station device of a communication system according to a fifth embodiment calculates a transmission weight coefficient Vⱼ and a reception weight coefficient Uₖ, and notifies the slave base station device and the mobile station device of the coefficients.

FIG. 19 is a diagram illustrating an example of CoMP.

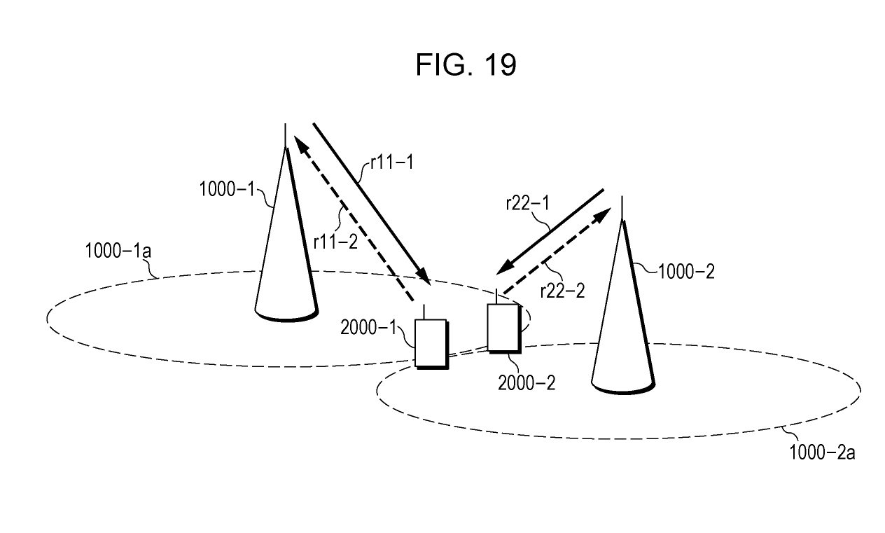

### DESCRIPTION OF EMBODIMENTS

Hereinafter, embodiments of the present invention will be described with reference to accompanying drawings.

### First Embodiment

An example will be described in which in a communication system 1 according to a first embodiment, a base station device 100-j and a mobile station device 200-k perform data transmission by using an orthogonal frequency division multiplexing (OFDM) scheme. Without being limited thereto, in the present embodiment, another transmission scheme, for example, a single-carrier transmission scheme such as a single carrier-frequency division multiple access (SC-FDMA), and a discrete Fourier transform-spread-OFDM (DFT-OFDM), a multi-carrier transmission scheme such as a multiple carrier-code division multiple access (MC-CDMA) may be used. Further, examples of the communication system 1 according to the first embodiment include wireless communication system such as Wideband Code Division Multiple Access (WCDMA) (registered trademark) by Third Generation Partnership Project (3GPP), Long Term Evolution (LTE), LTE-Advanced (LTE-A), and Worldwide Interoperability for Microwave Access (WiMAX) by The Institute of Electrical and Electronic engineers (IEEE), but is not limited thereto.

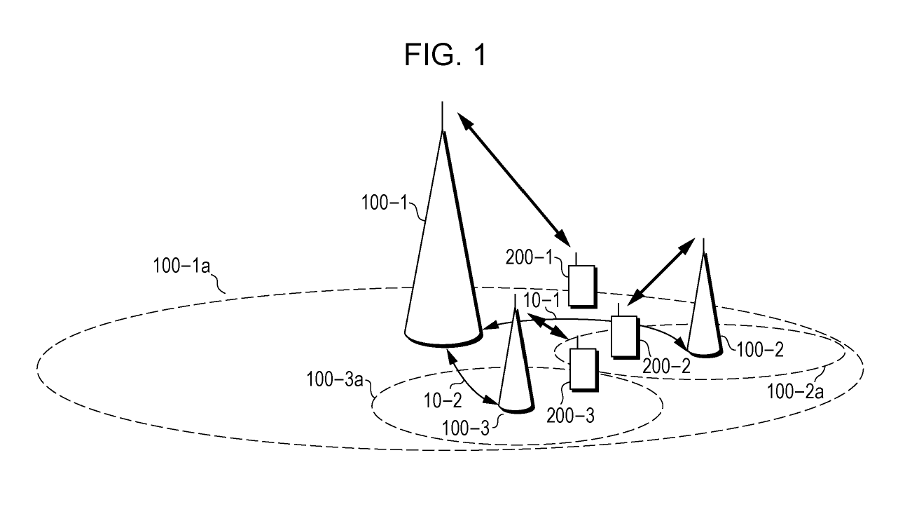

FIG. 1 is a schematic diagram illustrating a cellular structure of the communication system according to the first embodiment of the present invention. The communication system according to the first embodiment of the present invention includes a plurality of base station devices 100-j (j is an arbitrary positive integer, and in FIG. 1, it is assumed that j=1 to 3), and a plurality of mobile station devices 200-k (k is an arbitrary positive integer, and in FIG. 1, it is assumed that k=1 to 3).

In FIG. 1, the mobile station device 200-k is wirelessly connected to the base station device 100-j, in which k=j.

Each base station device 100-j is allocated in such a manner that all or part of its own cell (100-ja) overlaps a cell of a base station device. The base station devices 100-j are connected by backhauls 10-1 and 10-2 such as an optical fiber, an internet line, another wired line (for example, X2 interface), or a wireless line.

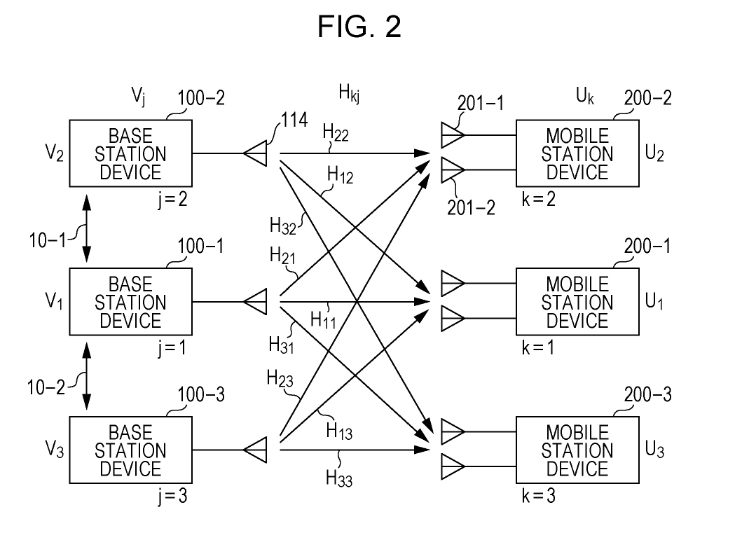

FIG. 2 is a schematic diagram illustrating a downlink channel of the communication system according to the first embodiment of the present invention. The base station device 100-j and the mobile station device 200-k in FIG. 2 correspond to the base station device 100-j and the mobile station device 200-k in FIG. 1.

A channel between the base station device 100-j and the mobile station device 200-k is expressed by Hₖⱼ (transfer function; k and j are arbitrary positive integers and assumed that k=1 to 3, and j=1 to 3, in FIG. 1). Here, the channel Hₖⱼ between the base station device and the mobile station device which are to cooperate with each other is referred to as a channel of an entire system.

A transmission signal from the base station device 100-j, where k=j, is a desired signal for the mobile station device 200-k. Further, the transmission signal from the base station device 100-j is inter-cell interference for the mobile station device 200-k, in which k≠j.

For example, a transmission signal from the base station device 100-1 which is received by the mobile station device 200-1 through a channel H₁₁ is a desired signal, and transmission signals from a base station device 100-2 and a base station device 100-3 which are received through a channel H₁₂ and a channel H₁₃ are inter-cell interference (undesired signals).

Each base station device 100-j multiplies signals to be transmitted by a transmission weight coefficient Vⱼ such that the base station device 100-j and the mobile station device 200-k cooperate with each other so as to suppress interference influenced to each other. In addition, in the mobile station device 200-k multiplies signals to be transmitted by a reception weight coefficient Uₖ such that the base station device 100-j and the mobile station device 200-k cooperate with each other so as to suppress interference influenced to each other.

Hereinafter, in the communication system of FIG. 2, it is assumed that the base station device 100-1 is a master base station device that calculates a transmission weight coefficient and a reception weight coefficient, and the base station device 100-2 and the base station device 100-3 are slave base station device that cooperatively operate in response to an instruction of the master base station device.

In addition, examples of the slave base station device include a device capable of performing a process for realizing the present invention, such as a relay station device, an access point (AP), and the like.

### [Master Base Station Device]

Next, the master base station device (base station device 100-1) according to the first embodiment will be described.

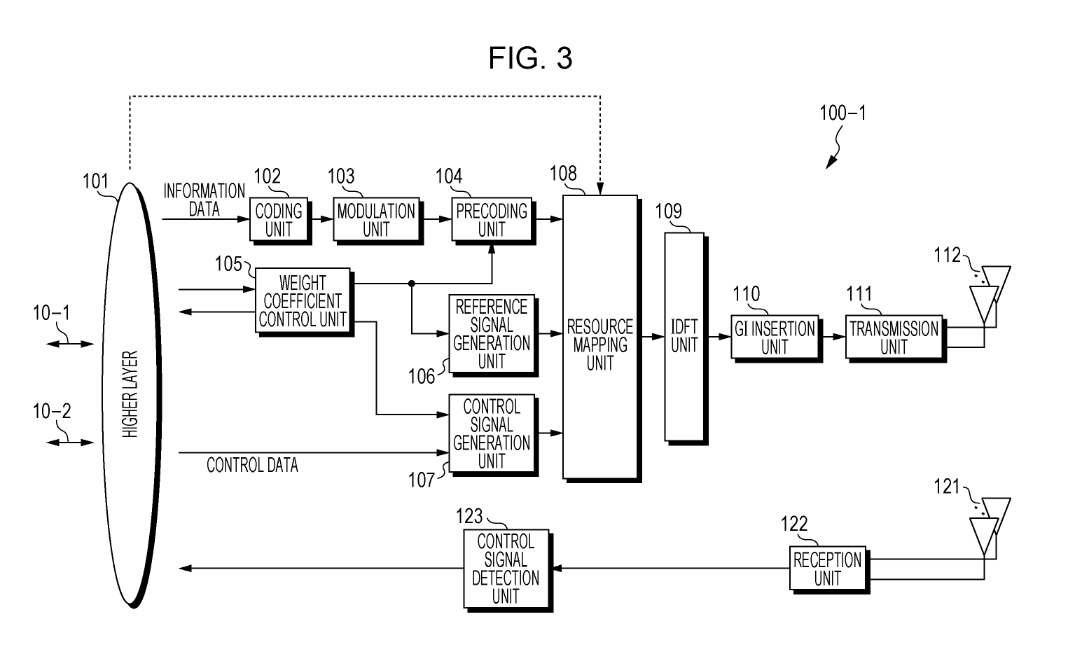

As illustrated in FIG. 3, the master base station device (base station device 100-1) is configured to include a higher layer 101, a coding unit 102, a modulation unit 103, a pre-coding unit 104, a weight coefficient control unit 105, a reference signal generation unit 106, a control signal generation unit 107, a resource mapping unit 108, an IDFT unit 109, a GI insertion unit 110, a transmission unit 111, a transmission antenna unit 112, a reception antenna unit 121, a reception unit 122, and a control signal detection unit 123. In addition, when part or all of the base station devices 100-1 are made into a chip as an integrated circuit, the base station devices 100-1 includes a chip control circuit (not shown) that controls each functional block.

In an uplink, the base station device 100-1 receives a signal transmitted by the mobile station device 200-1 though a reception antenna unit 121. The signal received by the base station device 100-1 includes signal containing a control signal (feedback information) such as channel statement information (CSI). The channel information is represented as explicit channel information (explicit CSI).

Further, the control signal may include information about a parameter of the transmission signal that the base station device transmits in a downlink. The information about parameters of the transmission signal corresponds to a channel quality indicator (CQI), the number of ranks and a spatial multiplexing number (rank indicator: RI) of MIMO, and information about scheduling of other downlinks.

The scheduling means determining a time (timing) and a frequency bandwidth of data transmission in a case of transmitting certain data, and scheduling information means information about the determined time and frequency bandwidth. For example, in LTE and LTE-A, the scheduling means determining a resource block to which information data is allocated. In addition, the resource block is an allocation unit of a signal which is configured with a plurality of a resource element which is a minimum unit for placing a signal configured with one subcarrier and one OFDM symbol, in OFDM transmission.

Further, the signal received by the base station device 100-1 includes a reference signal for measuring uplink channel information. The sounding reference signals of LTE and LTE-A, and the like may be used as the reference signal.

The reception unit 122 down-converts the control signal and the like into a frequency band signal at which a digital signal process such as a signal detection process is available (radio frequency conversion), performs a filtering process of removing a spurious, and performs the filtered signal from an analog signal to a digital signal (analog to digital conversion).

The control signal detection unit 123 performs a demodulation process and decoding process on the signal which is output by the reception unit 122, and detects a control signal. The control signal is detected from a physical uplink control channel (PUCCH), a physical uplink shared channel (PUSCH), and the like.

The higher layer 101 acquires channel information contained in the control signal input from the control signal detection unit 123. The channel information is channel information that is measured by the mobile station device 200-1 connected to the base station device 100-1.

For example, as the channel information, the higher layer 101 acquires channel information H₁₁ between the base station device 100-1 and the mobile station device 200-1, channel information H₁₂ between the base station device 100-2 and the mobile station device 200-1, and channel information H₁₃ between the base station device 100-3 and the mobile station device 200-1.

In addition, the higher layer 101 can acquire information (CQI, RI, other information about scheduling, and the like) about a parameter of a transmission signal contained in the control signal which is input from the control signal detection unit 123. The information about parameters of a transmission signal may be used for scheduling a signal to be transmitted to the mobile station device connected to its own base station device.

Here, the higher layer is a hierarchy of a higher function than a physical layer, for example, a data link layer, a network layer, and the like, among hierarchies of communication functions defined in an OSI reference model.

Further, the higher layer 101 acquires channel information from the slave base station devices (the base station device 100-2 and the base station device 100-3) through backhauls 10-1 and 10-2.

For example, the higher layer 101 acquires channel information (information about the channel H₂₁) between the base station device 100-1 and the mobile station device 200-2, channel information (information about the channel H₂₂) between the base station device 100-2 and the mobile station device 200-2, and channel information (information about the channel H₂₃) between the base station device 100-3 and the mobile station device 200-2, through the backhaul 10-1. Further, the higher layer 101 acquires channel information (information about the channel H31) between the base station device 100-1 and the mobile station device 200-3, channel information (information about the channel H₃₂) between the base station device 100-2 and the mobile station device 200-3, and channel information (information about the channel H₃₃) between the base station device 100-3 and the mobile station device 200-3, through the backhaul 10-2.

In other words, the master base station device acquires channel information which is a result from each mobile station device's estimation of changes in channels between each mobile station device 200-k and the base station devices (the master base station device and the slave base station devices) which perform cooperative control.

Further, the higher layer 101 can acquire information (CQI, RI, other information about scheduling, and the like) about parameters of transmission signals that are transmitted by the slave base station devices in the downlink, from the slave base station devices (the base station device 100-2 and the base station device 100-3), through the backhauls 10-1 and 10-2. The information about the parameters of the transmission signals are acquired by the slave base station device, from the mobile station device connected to the slave base station device.

Further, the higher layer 101 may include a scheduling unit that performs scheduling of signals that the master base station device 100-1 and the slave base station devices transmit, by using the acquired information (CQI, RI, other information about scheduling, and the like) about the parameters of the transmission signals. For example, in the communication system of FIG. 2, the scheduling unit can perform scheduling of a signal that the base station device 100-1 transmits to the mobile station device 200-1 connected to its own base station device, a signal that the base station device 100-2 transmits to the mobile station device 200-2 connected to its own base station device, and a signal that the base station device 100-3 transmits to the mobile station device 200-3 connected to its own base station device.

In addition, each slave base station device may individually perform the scheduling of a signal that each slave base station device transmits to the mobile station device connected to its own base station device. In such as case, each slave base station device can notify the master base station device of the scheduling result.

Further, the higher layer 101 inputs the acquired channel information to the weight coefficient control unit 105. Here, the higher layer 101 may be configured to input the information about base station devices cooperating with each other (for example, IDs of the base station devices cooperating with each other, the number of base station devices cooperating with each other, the number of mobile station devices, and the like), and the scheduling result to the weight coefficient control unit 105. Further, the higher layer 101 can notify the weight coefficient control unit 105 of the information about a parameter of a transmission signal (CQI, RI, other information about scheduling, and the like).

Further, the higher layer 101 notifies the slave base station device of a transmission weight coefficient or/and a reception weight coefficient which are calculated in a weight coefficient control unit 105 which will be described later, through the backhauls 10-1 and 10-2. The higher layer 101 of the base station device 100-1 notifies the base station device 100-2 of a transmission weight coefficient V₂ to be multiplied to the transmission signal by the base station device 100-2 or/and a reception weight coefficient U₂ to be multiplied to the reception signal by the mobile station device 200-2, through the backhaul 10-1. The higher layer 101 of the base station device 100-1 notifies the base station device 100-3 of a transmission weight coefficient V3 to be multiplied to the transmission signal by the base station device 100-3 or/and a reception weight coefficient U₃ to be multiplied to the reception signal by the mobile station device 200-3, through the backhaul 10-2.

Further, the higher layer 101 outputs information data to the coding unit 102, and outputs control data to the control signal generation unit 107.

In addition, the higher layer 101 notifies other parameters required for respective units constituting the base station device 100-1 to exert functions.

The coding unit 102 performs error correction coding on information data which is input from the higher layer 101. Examples of the information data include an audio signal associated with a call, a still image signal or a moving image signal representing a captured image, and a text message. The coding scheme used by the coding unit 102 when performing the error correction coding is, for example, turbo coding, convolutional coding, low density parity check coding (LDPC), and the like.

In addition, the coding unit 102 may perform a rate matching process on a coded bit sequence in order to adapt a coding rate of a data sequence subjected to the error correction coding to a coding rate corresponding to a data transmission rate. Further, the coding unit 102 may have a function of rearranging and interleaving the data sequence subjected to the error correction coding.

The modulation unit 103 generates a modulation symbol by modulating a signal which is input from the coding unit 102. The modulation process performed by the modulation unit 103 is binary phase shift keying (BPSK), quadrature phase shift keying (QPSK), quadrature amplitude modulation (QAM), and the like. In addition, the modulation unit 103 may have a function of rearranging and interleaving the generated modulation symbol.

The weight coefficient control unit 105 calculates a transmission weight coefficient Vⱼ to be multiplied by the transmission signals by the master base station device and the slave base stations, and a reception weight coefficient Uₖ to be multiplied by the reception signal by the mobile station device connected to each base station device, by using the channel information acquired from the higher layer 101. In other words, the weight coefficient control unit 105 calculates the transmission weight coefficient and the reception weight coefficient, by using the channel information of an entire system.

As an aspect, the weight coefficient control unit 105 calculates the transmission weight coefficient such that the directions (vectors) of equivalent channels of interference signals arrived from a plurality of base station devices which are interference sources are orthogonal to the reception weight coefficient to be multiplied by the reception signal in each mobile station device (Equation (1)).

[Equation 1]

Uₖ^{H}HₖⱼVⱼ=0,∀j≠k

rank(Uₖ^{H}HₖₖVₖ)=dₖ (1)

Here, Hₖⱼ is a channel matrix between the base station device 100-j and the mobile station device 200-k which is a subject of cooperative control, Vⱼ is a vector of the transmission weight coefficient of the base station device 100-j, Uₖ is a vector of the reception weight coefficient of the mobile station device 200-k, and dₖ is the number of streams. ^{H} is a complex conjugate transpose.

Further, the weight coefficient control unit 105 notifies the higher layer 101 of the transmission weight coefficient Vⱼ of the slave base station device and the reception weight coefficient Uₖ of the mobile station device connected to the slave base station device.

Further, the weight coefficient control unit 105 outputs the transmission weight coefficient V₁ to be multiplied by the transmission signal of the master base station device (its own station) to the pre-coding unit 104. Further, the weight coefficient control unit 105 outputs the reception weight coefficient U₁ of the mobile station device connected to the master base station device (its own station), to the control signal generation unit 107.

In addition, the case where the weight coefficient control unit 105 calculates the transmission weight coefficient and the reception weight coefficient has been described above, but it is possible to calculate only the transmission weight coefficient.

The pre-coding unit 104 multiplies the modulation symbol which is output by the modulation unit 103 with the transmission weight coefficient V₁.

The reference signal generation unit 106 generates a reference signal (pilot signal), and outputs the generated reference signal to the resource mapping unit 108. For example, the reference signal is a signal used for estimating the channel characteristics from the transmission antenna unit 112 of the base station device to the reception antenna units 201-1 and 201-2 of each mobile station device. The estimated channel characteristics are used for the channel information for calculation of the transmission weight coefficient and the reception weight coefficient, or channel compensation of the mobile station device. In addition, it is preferable that the code sequence constituting the reference signal be an orthogonal sequence, for example, Hadamard code or constant amplitude zero auto-correlation (CAZAC) sequence.

The control signal generation unit 107 generates a control signal containing control data which is output by the higher layer 101, and a reception weight coefficient U₁ (a reception weight coefficient of the mobile station device connected to its own station) which is output by the weight coefficient control unit 105. Here, the control signal generation unit 107 which generates the control signal containing the weight coefficient may correspond to a weight coefficient information generation unit, and the control signal containing the weight coefficient generated by the control signal generation unit may correspond to the weight coefficient information. Further, an error correction coding and a modulation process may be performed on the control signal.

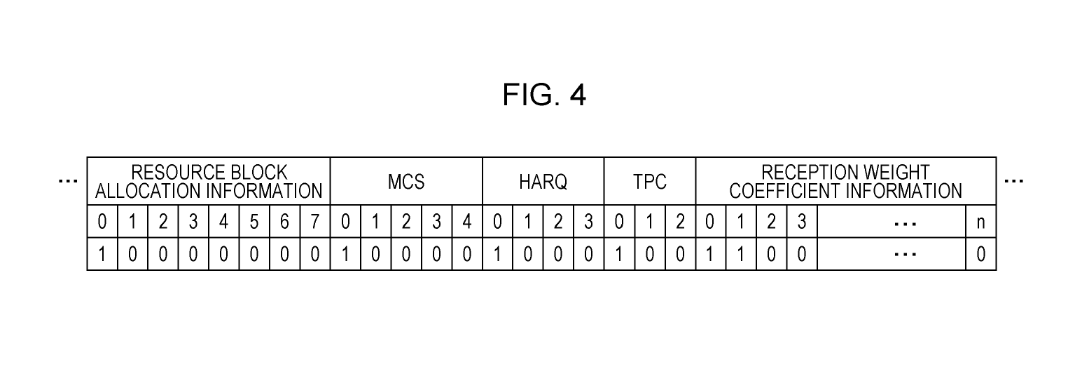

FIG. 4 is a conceptual diagram illustrating an example of a format of a control signal that is output by the control signal generation unit 107. The control signal has an area for storing information about the reception weight coefficient of the mobile station device connected to its own station. In the communication system of FIG. 2, an area for storing information about the reception weight coefficient is provided, with the reception weight coefficient U₁ to be multiplied by the reception signal by the mobile station device 200-1 connected to the base station device 100-1 as the information.

Further, it is possible to provide an area for storing information about a resource block in which a signal addressed to the mobile station device is allocated, a modulation level (modulation and coding scheme (MCS)), a transmission power control command (TPC command), the number of times of retransmission of HARQ, and the like, in the control signal.

For example, it is possible to use physical downlink control channel (PDCCH), in LTE, and LTE-A.

In addition, control signal generation unit 107 generates a synchronization single for establishing and tracking the synchronization such symbol synchronization and frame synchronization, a broadcast channel (for example, physical broadcast channel (PBCH) in LTE and LTE-A). It is possible to use a primary synchronization signal (PSS) and a secondary synchronization signal (SSS) as the synchronization signal, in LTE and LTE-A.

The resource mapping unit 108 maps a signal which is output by the pre-coding unit and a signal which is output by the pre-coding unit to a certain subcarrier of a certain OFDM symbol, based on scheduling information notified from the higher layer 101 (hereinafter, referred to as resource mapping).

The IDFT unit 109 converts a frequency domain signal which is input from the resource mapping unit 108 into a time domain signal through an inverse discrete Fourier transform (IDFT). As long as the frequency domain signal can be converted into the time domain signal, the IDFT unit 109 may use other processing method (for example, inverse fast Fourier transform (IFFT), instead of the IDFT.

The GI insertion unit 110 generates an OFDM symbol by adding a guard interval (GI) to the time domain signal (referred to as an effective symbol) which is input from the IDFT unit 109. The GI is an interval to be added in order for OFDM symbols between times not to interfere to each other. For example, the GI insertion unit 110 prefixes the GI to the effective symbol, with the copy of an interval of a latter part of the effective symbol as the GI. Thus, the effective symbol to which GI is prefixed is an OFDM symbol.

The transmission unit 111 generates an analog signal by D/A (digital-to-analog) converting the OFDM symbol which is input from the GI insertion unit 110. Further, the transmission unit 111 generates a band-limited signal by limiting a band of the generated analog signal through a filtering process. The transmission unit 111 up-converts the generated band-limited signal into a radio frequency band signal, and outputs the radio frequency band signal to the transmission antenna unit 112.

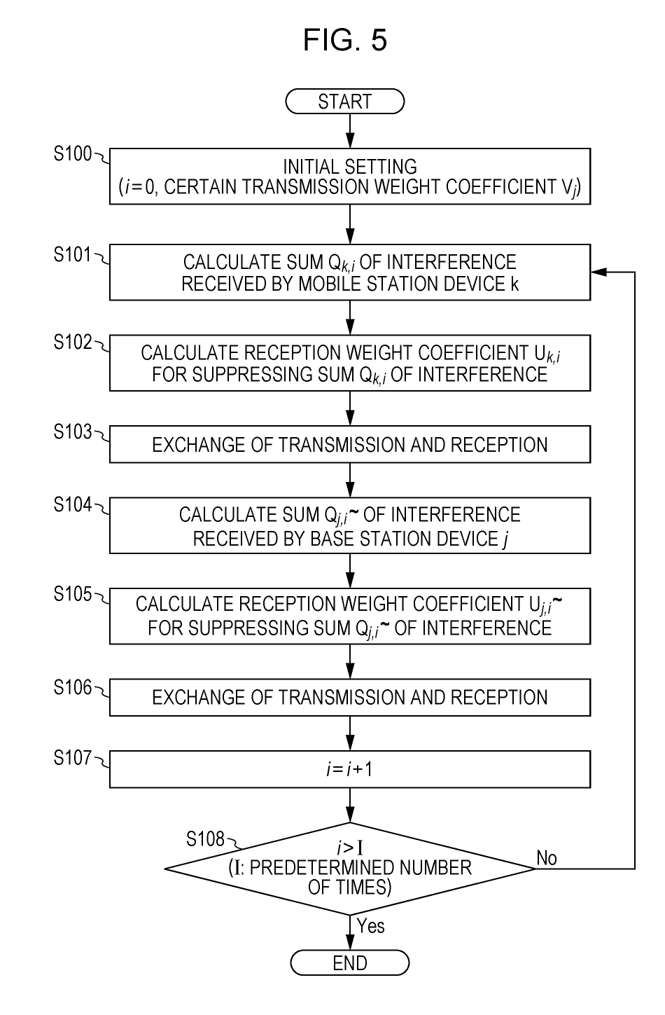

Next, a process of calculating the transmission weight coefficient Vⱼ and the reception weight coefficient Uₖ in the communication system will be described. FIG. 5 is a flowchart illustrating a process in which the weight coefficient control unit 105 calculates the transmission weight coefficient Vⱼ and the reception weight coefficient Uₖ.

The calculation method of FIG. 5 repeats a process of obtaining the weight coefficient having influence of interference as small as possible, while replacing the roles of the transmission and reception, by using the property (reciprocity of the channel) that the complex conjugate transposed matrix of a channel matrix from the base station device to the mobile station device is the channel matrix from the mobile station device to the base station device.

First, if the channel information is acquired, the weight coefficient control unit 105 sets a certain transmission weight coefficient Vⱼ (S100).

Next, the weight coefficient control unit 105 calculates the sum Q_{k,i} of an interference received by the mobile station device 200-k based on Equation (2) (S101). Here, Q is the covariance matrix of the received interference signal. Further, P is the transmission power, and K is the number of mobile station devices which are subjects of cooperative control. Further, ^{H} denotes the complex conjugate transpose.

$$\begin{matrix}[ Equation 2 ] & \\ {Q}_{k , l} = {\sum }_{j = 1 , j \neq k}^{K} \frac{{P}_{j}}{{d}_{j}} {H}_{kj} {V}_{j , i} {V}_{j , i}^{H} {H}_{kj}^{H} & ( 2 )\end{matrix}$$

Next, the weight coefficient control unit 105 performs singular value decomposition on the calculated sum _{Qk,i} of an interference, and calculates a reception weight coefficient U_{k,i} for suppressing the sum Q_{k,i} of an interference (S102). Further, in step S102 and step S103, it is assumed that the reception weight coefficient Uₖ is calculated for a case where the mobile station device 200-k receives the transmission signal of the base station device 100-j.

Next, the roles of the transmission and the reception of the base station device 100-j and the mobile station device 200-k are exchanged (S103). In other words, mobile station device 200-k calculates the reception weight coefficient Uₖ^{˜} of the base station device 100-j for the case where the base station device 100-j receives the transmission signal multiplied by the coefficients U_{k,i}. The reception weight coefficient Uₖ^{˜} corresponds to the transmission weight coefficient Vₖ of base station device 100-j.

For the calculation of the reception weight coefficient Uₖ^{˜}, first, the sum of the interference Q_{j,i}^{˜} received by the base station device 100-j is calculated based on Equation (3) (S104). Here, Hⱼₖ^{˜}=Hₖⱼ^{H}, Vₖ^{˜}=Uₖ, and P^{˜} is transmission power.

$$\begin{matrix}[ Equation 3 ] & \\ {\tilde{Q}}_{j} = {\sum }_{k = 1 , k \neq j}^{K} \frac{{\tilde{P}}_{k}}{{d}_{k}} {\tilde{H}}_{jk} {\tilde{V}}_{k} {\tilde{V}}_{k}^{H} {\tilde{H}}_{jk}^{H} & ( 3 )\end{matrix}$$

Next, the reception weight coefficient U_{k,i}^{˜} suppressing the sum of the interference Q_{j,i}^{˜} is calculated by performing singular value decomposition on the sum of the interference Q_{j,i}^{˜} (S105). Again, the roles of the transmission and the reception of the base station device 100-j and the mobile station device 200-k are exchanged (S106). In other words, it is substituted that V_{k,j}=U_{k,i}^{˜}.

A counter for counting the number of processes is incremented by one (S107), and until reaching a predetermined number of times I (in S108, N), the process of step S101 to step S106 is repeated. When it reaches the predetermined number of times I (in S108, Y), the process is terminated.

In this manner, while exchanging the roles of the transmission and the reception of the base station device 100-j and the mobile station device 200-k, the reception weight coefficients (Uₖ, Uₖ^{˜}) at which the interference power is reduced is repeatedly updated, such that it is achieved a reception weight coefficient at which the base station device 100-j and the mobile station device 200-k suppress the influence of interference.

If the reception weight coefficient Uₖ^{˜} at k=j is assumed as the transmission weight coefficient Vⱼ of the base station device 100-j, and the reception weight coefficient Uₖ is assumed as the reception weight coefficient Uₖ of the mobile station device 200-k, a plurality of base station devices 100-j can cooperate so as to reduce the influence of interference. The calculation method is an example, but without being limited thereto, other calculation methods may be used.

[Slave Base Station Device]

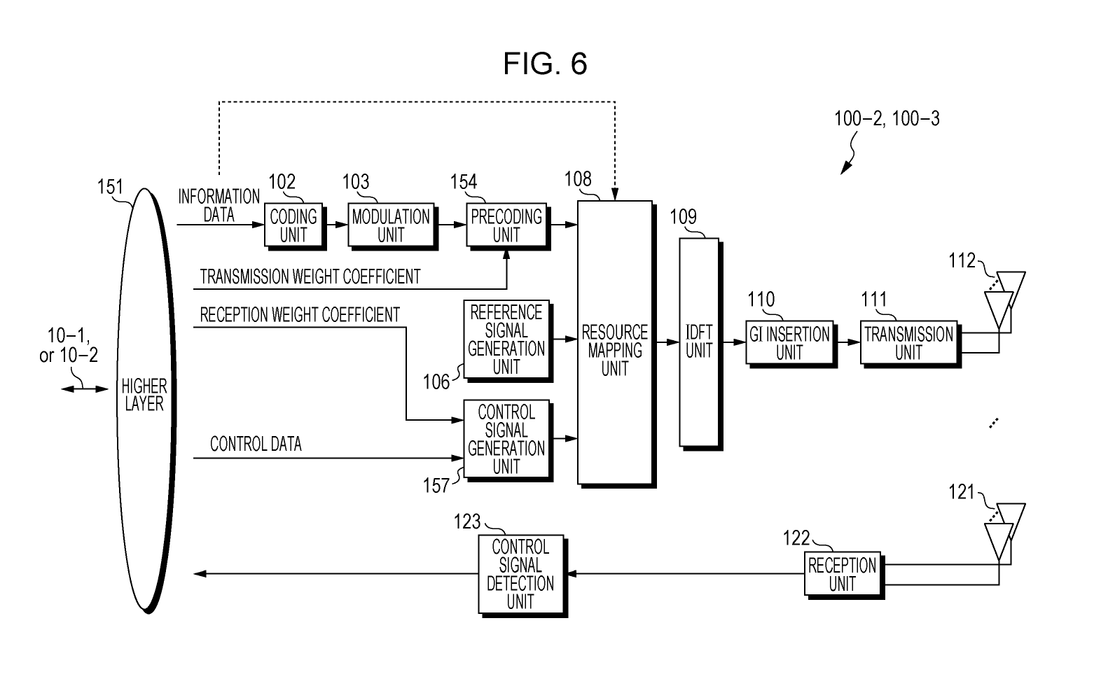

Next, the slave base station device according to the first embodiment (the base station device 100-2 and the base station device 100-3) will be described. FIG. 6 is a schematic diagram illustrating a configuration of the slave base station device (the base station device 100-2 and the base station device 100-3) according to the first embodiment. Hereinafter, the configuration of the base station device 100-2 will be described, but the base station device 100-3 has the same configuration.

The base station device 100-2 is configured to include a higher layer 151, a coding unit 102, a modulation unit 103, a pre-coding unit 154, a reference signal generation unit 106, a control signal generation unit 157, a resource mapping unit 108, an IDFT unit 109, a GI insertion unit 110, a transmission unit 111, a transmission antenna unit 112, a reception antenna unit 121, a reception unit 122, and a control signal detection unit 123. Further, when part or all of the base station device 100-2 is made into a chip as an integrated circuit, the base station device 100-2 includes a chip control circuit (not shown) that controls each functional block.

In comparison with the base station device 100-1, the base station device 100-1 is different from the base station device 100-2 in having different operations of the higher layer 151, the pre-coding unit 154, and the control signal generation unit 157. The following mainly describes the different components.

The higher layer 151 acquires channel information contained in a control signal which is input from the control signal detection unit 123.

Specifically, the higher layer 151 acquires the channel information (a channel information H₂₁, between the base station device 100-1 and the mobile station device 200-2, a channel information H₂₂ between the base station device 100-2 and the mobile station device 200-2, and a channel information H₂₃ between the base station device 100-3 and the mobile station device 200-2) contained in the control signal which is input from the control signal detection unit 123.

Further, the higher layer 151 notifies the master base station device 100-1 calculating the weight coefficient of the channel information, through the backhauls 10-1.

Further, the higher layer 151 can notify the master base station device 100-1 of information (CQI, RI, other information about scheduling, and the like) about the parameters of a transmission signal which is transmitted by the slave base station device 100-2 in the downlink, through the backhaul 10-1. The information about the parameters of the transmission signal is achieved by the slave base station device, from a mobile station device connected to the slave base station device.

Further, the higher layer 151 can perform scheduling such as MCS of the transmission signal to be transmitted to the mobile station device connected to the base station device 100-2 which is its own station and decision of resource blocks to be allocated, based on the information (CQI, RI, other information about scheduling, and the like) about the parameters of the transmission signal. In such a case, the higher layer 151 can notify the master base station device 100-1 of the scheduling result, through the backhaul 10-1.

Further, the higher layer 151 acquires the transmission weight coefficient V₂ to be multiplied by the transmission signal of its own station and the reception weight coefficient U₂ of the mobile station device 200-2 connected to its own station, from the backhaul 10-1.

Further, the higher layer 151 inputs the transmission weight coefficient V₂ to the pre-coding unit 154. Further, the higher layer 151 inputs the reception weight coefficient U₂ to the control signal generation unit 157.

The pre-coding unit 154 multiplies the transmission weight coefficient V₂ by the modulation symbol which is output by the modulation unit 103.

The control signal generation unit 157 outputs a control signal containing control data and the reception weight coefficient U₂ which are output by the higher layer 151 (the reception weight coefficient of the mobile station device 200-2 connected to its own station). Similarly, the format illustrated in FIG. 5 is applied to the format of the control signal. In other words, the control signal generation unit 157 has an area of storing the reception weight coefficient information U₂ of the mobile station device 200-2.

[Downlink Transmission Format of Communication System]

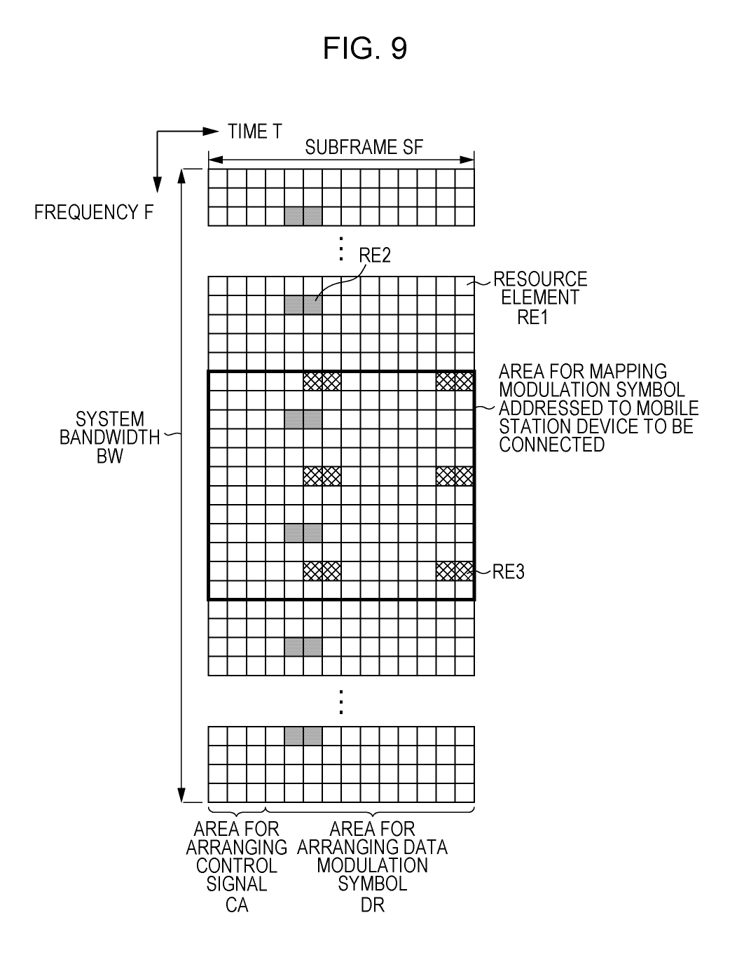

FIG. 9 is an example of resource mapping of the resource mapping unit 108 of the base station device. In FIG. 9, the horizontal axis represents a time T, and the vertical axis represents a frequency F.

In FIG. 9, a white part RE1 is a resource element for mapping a control signal (a signal output by the control signal generation unit 107) and information data (a signal output by the pre-coding unit 104). A thick area is an area MA to which information data of the mobile station device notified of the reception weight coefficient is mapped. For example, the resource mapping unit 108 of the base station device 100-1 maps information data transmitted to the mobile station device 200-1 to the area MA.

Further, a solid part RE2 and a cross-hatched part RE3 are resource elements for mapping a reference signal. The resource element for mapping the reference signal shown as the cross-hatched part RE3 is a resource element for mapping a cell-specific reference signal (a first reference signal).

The first reference signals are orthogonal to each other between cells. For example, the first reference signals maintain orthogonality by code division multiplexing (CDM), frequency division multiplexing (FDM), and time division multiplexing (TDM).

Further, the resource element for mapping the reference signal shown as the solid part RE2 is a resource element for mapping a user-specific reference signal (second reference signal).

The second reference signals are also to be orthogonal to each other between cells. In such as case, the second reference signals can maintain orthogonality by code division multiplexing (CDM), frequency division multiplexing (FDM), and time division multiplexing (TDM).

For example, in LTE, and LTE-A, it is possible to use a cell-specific reference signal (CRS) and a channel statement information-reference signal (CSI-RS), as the first reference signal. Further, in LTE and LTE-A, it is possible to use a demodulation-reference signal (DM-RS), as the first reference signal.

[Mobile Station Device]

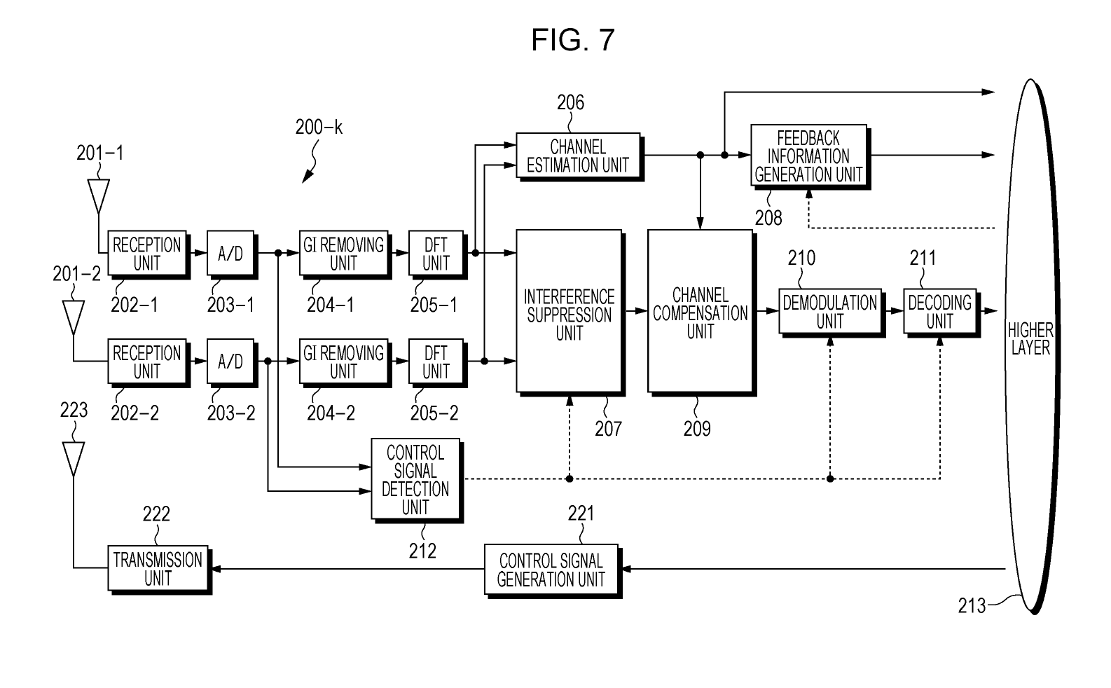

Next, the mobile station device 200-k according to the first embodiment will be described. FIG. 7 is a schematic diagram illustrating a configuration of the mobile station device 200-k according to the first embodiment.

The mobile station device 200-k is configured to include a plurality of reception antenna units 201-e, a plurality of reception units 202-e, a plurality of A/D units 203-e, a plurality of GI removing unit 204-e, a plurality of DFT unit 205-e, a channel estimation unit 206, an interference suppression unit 207, a feedback information generation unit 208, a channel compensation unit 209, a demodulation unit 210, a decoding unit 211, a control signal detection unit 212, a higher layer 213, a control signal generation unit 221, a transmission unit 222, and a transmission antenna unit 223. Further, e is the number of antennas of the mobile station. Although FIG. 7 illustrates a case where the mobile station device 200-k has two (e=2) reception antennas, without being limited, an arbitrary number of antennas may be included. Further, the number of transmission antennas is one, but without being limited, a plurality of transmission antennas may be included, and the transmission antenna and the reception antenna may be configured to be shared. Further, when part or all of the mobile station device 200-k is made into a chip as an integrated circuit, the mobile station devices 200-k includes a chip control circuit (not shown) that controls each functional block.

The mobile station device 200-k receives a transmission signal from the base station device 100-j through the reception antenna unit 201-e. Here, when the mobile station device 200-m (a set of mεk) is connected to the base station device 100-m, the signal transmitted by a base station device other than the base station device 100-m is an inter-cell interference for the mobile station device 200-m.

The reception unit 202-e down-converts a radio frequency signal, which is input from the reception antenna units 201-e, into a frequency band signal in which a digital signal process is available, and suppresses unnecessary components (spurious) by performing a filtering process on the down-converted signal.

The A/D unit 203-e obtains a digital signal by performing an analog-to-digital (A/D) transform on the analog signal subjected to the filtering process, and outputs the converted digital signal to the GI removing unit 204-e and the control signal detection unit 212.

The GI removing unit 204-e removes a guide interval GI from the signal which is output from the A/D unit 203-e in order to avoid a distortion caused by a delay wave, and outputs the signal obtained by GI being removed to the DFT unit 205-e.

The DFT unit 205-e performs a discrete Fourier transform (DFT) that converts a time domain signal into a frequency domain signal, on the signal obtained by guide interval GI being removed which is input from the GI removing unit 204-e, and outputs the converted signal to the channel estimation unit 206 and the interference suppression unit 207. Further, without being limited to DFT, and if a signal can be transformed from the time domain to the frequency domain, the DFT unit 205-e may perform other methods, for example, fast Fourier transform (FFT) or the like.

The channel estimation unit 206 de-samples a pilot signal for channel estimation (reference signal) included in the signal which is output by the DFT unit 205-e, and performs channel estimation by using the pilot signal. The channel estimated value (channel information) is, for example, transfer function.

Specifically, the channel estimation unit 206 estimates a channel between its own mobile station device and the base station device connected to the mobile station device by using the pilot signal transmitted by the base station device connected to its own base station device. Further, the channel estimation unit 206 estimates channels between its own mobile station device and a base station device other than the base station device connected to the mobile station device by using the pilot signal transmitted by the base station device connected to its own base station device. Then, the channel estimation unit 206 notifies the channel compensation unit 209 and the feedback information generation unit 208 of the channel estimated value between its own mobile station device and the base station device connected to the mobile station device. Further, the channel estimation unit 206 notifies the feedback information generation unit 208 of the channel estimated value between its own mobile station device and the base station device connected to the mobile station device and the channel estimated value between its own mobile station device and the base station device other than the base station device connected to the mobile station device.

If Ĥₖⱼ is assumed as the channel estimated value between the mobile station device 200-k and the base station device 100-j calculated by the channel estimation unit 206, Ĥₖⱼ can be calculated based on, for example, Equation (4).

$$\begin{matrix}[ Equation 4 ] & \\ {\hat{H}}_{kj} = \frac{{H}_{kj} {S}_{j}}{{\tilde{S}}_{j}} & ( 4 )\end{matrix}$$

Here, Sⱼ is a pilot signal which is transmitted by the base station device 100-j, S^{˜}ⱼ is a pilot signal of the base station device 100-j that the mobile station device 200-k can know.

The feedback information generation unit 208 generates the feedback information to be notified from the mobile station device to the base station device, by using the channel estimated value which is input from the channel estimation unit 206.

The feedback information is channel information used in the calculation of the transmission weight coefficient Vⱼ and/or the reception weight coefficient Uₖ by the master base station device.

The feedback information generation unit 208 has a function of adjusting an amount of information used to represent the channel estimation value input from the channel estimation unit 206, in response to each base station apparatus. In other words, among the feedback information amount used for representing a channel estimated value between the mobile station device and the base station device connected to the mobile station device and the feedback information amount used for representing channel estimated value between the mobile station device and the base station device other than the base station device connected to the mobile station device, the feedback information amount used for representing one channel estimated value can be adjusted so as to be less than the feedback information amount used for representing the other channel estimated value.

As one aspect, the feedback information generation unit 208 has a function of adjusting the number of quantization bits of the channel information which is input from the channel estimation unit 206, depending on each base station device.

Specifically, among the channel information between the mobile station device and the base station device connected to the mobile station device and the channel information between the mobile station device and the base station device other than the base station device connected to the mobile station device, the number of quantization bits of one channel information can be adjusted so as to be less than the number of quantization bits of the other channel information. This is effective because the master base station device can reduce the amount of feedback information used for calculating the weight coefficient.

The feedback information generation unit 208 can reduce the amount of the channel information between the mobile station device and the base station device other than the base station device connected to the mobile station device than the number of quantization bits of the channel information between the mobile station device and the base station device connected to the mobile station device.

Thus, the number of base station devices other than the base station device connected to the mobile station device is greater than the number of the base station devices connected to the mobile station device, there is a significant effect of reducing the amount of feedback information.

Further, the feedback information generation unit 208 can reduce the number of quantization bits of the channel information between the mobile station device and the base station device connected to the mobile station device than the number of quantization bits of the channel information between the mobile station device and the base station device other than the base station device connected to the mobile station device.

The channel information is used to suppress the interference (inter-cell interference) received from the mobile station device and the base station device other than the base station device connected to the mobile station device.

Therefore, it is effective because it is possible to reduce the amount of feedback information while suppressing the reduction of the interference suppression function, by suppressing the number of quantization bits of the channel information between the mobile station device and the base station device connected to the mobile station device than the number of quantization bits of the channel information between the mobile station device and the base station device other than the base station device connected to the mobile station device.

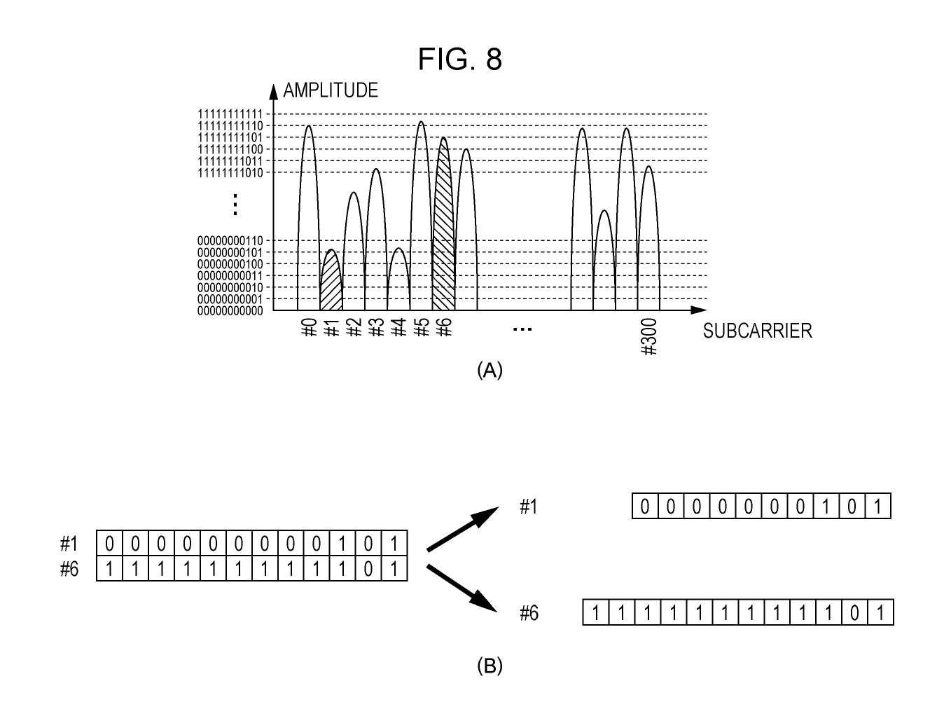

FIG. 8 is an aspect of a method in which the feedback information generation unit adjusts the number of quantization bits.

FIG. 8(A) illustrates amplitudes of respective subcarriers after the DFT unit 205 transforms the reception signal in the time domain into a frequency domain signal. The horizontal axis represents a subcarrier index, and the vertical axis represents the amplitude. In FIG. 8(A), the amplitude is quantized to 12 bits. Further, it is assumed that #1 is the subcarrier index in which the reference signal transmitted by the base station device connected to the mobile station device of its own station is mapped, and #6 is the subcarrier index in which the reference signal transmitted by the base station device other than the base station device connected to the mobile station device of its own station is mapped.

The channel estimation unit 206 inputs the amplitude of the subcarrier indexes #1 and #6 illustrated on the left side of FIG. 8(B), to the feedback information generation unit 208, as one type of the channel information. In addition, the channel estimation unit 206 also inputs the quantized phase of the subcarrier indexes #1 and #6, to the feedback information generation unit 208, as one type of the channel information, in a similar manner.

For example, the feedback information generation unit 208 reduces the number of quantization bits of the amplitude and phase of the subcarrier index #1 which is the channel information between the mobile station device and the base station device connected to the mobile station device. An example in which the number of quantization bits of the amplitude is reduced by deleting the upper two bits among the quantized amplitude of the subcarrier index #1 is illustrated on the right side of FIG. 8(B). In addition, as the method for reducing the number of quantization bits, a method of deleting the upper two bits of FIG. 8(B) is used, but a method of deleting the lower two bits may be used. Further, the amplitude which has been quantized into 12 bits is converted into an analog signal by D/A conversion, and thereafter, the amplitude is quantized into 10 bits and thereafter is D/A converted, such that it is possible to reduce the number of quantization bits.

Meanwhile, the feedback information generation unit 208 maintains the number of quantization bits of the amplitude and phase of the subcarrier index #2 which is channel information between the mobile station device and the base station device other than the base station device connected to the mobile station device, as it is.

In addition, in FIG. 8(B), the feedback information generation unit 208 adjusts the number of quantization bits by maintaining the number of quantization bits of the channel information between the mobile station device and the base station device other than the base station device connected to the mobile station device, but is not limited thereto.

For example, the reduced number of the number of quantization bits of the channel information between the mobile station device and the base station device connected to the mobile station device is different from the reduced number of the number of quantization bits of the channel information between the mobile station device and the base station device other than the base station device connected to the mobile station device, it is possible to achieve the same effect.

The feedback information generation unit 208 determines which base station device has transmitted the pilot signal, based on the placement information of the pilot signal for channel estimation notified from the higher layer 213.

Then, as described the above method, the channel estimated value after the amount of information used to represent the channel estimated value is adjusted is notified to the higher layer.

The control signal detection unit 212 performs detection of the control signal included in a signal output by the A/D unit 203-e. Then, if the reception weight coefficient information (see FIG. 4) included in the control signal is extracted, the control signal detection unit 212 inputs the reception coefficient information to the interference suppression unit 207.

Further, the control signal detection unit 212 extracts various types of information such as resource block allocation information, MCS information, HARQ information, and TPC information which are included in the control signal. Then, information about information data addressed to its own station (allocation position of information data addressed to its own station, MCS performed in the information data, and the like) is detected from the extracted various types of information, and is notified to the demodulation unit 210 and the decoding unit 211.

The interference suppression unit 207 multiplies the signal in the frequency domain input from the DFT unit 206-e with the reception weight coefficient U input from the control signal detection unit 212.

The channel compensation unit 209 calculates a weight coefficient for correcting the channel distortion due to fading, by using a method such as zero forcing (ZF) equalization, and minimum mean square error (MMSE) equalization, based on the channel estimated value input from the channel estimation unit 206. Further, the channel compensator 209 performs channel compensation by multiplying the signal input from the interference suppression unit 207 with the weight coefficient.

The demodulation unit 210 performs the demodulation process on the channel compensated signal (data modulation symbol) which is input from the channel compensation unit 209. The demodulation process may be either hard decision (calculation of coded bit sequence), and soft decision (calculation of coded bit LLR).

The decoding unit 211 calculates the information data transmitted to the decoding unit 211, by performing the error correction decoding process on the demodulated coded bit sequence (or, coded bit LLR) which is output by the demodulation unit 210, and outputs the information data to the higher layer 213. The method of the error correction decoding process is a method corresponding to the error correction coding such as turbo coding performed by the base station device 100-m connected thereto, and convolution coding. The error correction decoding process can be applied to either a hard decision or a soft decision.

Further, when the base station device 100-j transmits the interleaved-data modulation symbol, the decoding unit 211 performs a de-interleave process corresponding to the interleave process on the input encoded bit sequence, prior to performing the error correction decoding process. Then the decoding unit 211 performs the error correction decoding process on the signal subjected to the de-interleave process.

The control signal generation unit 221 generates control data containing feedback information generated by the feedback information generation unit 208.

For example, in the communication system of FIG. 1, the control signal of the mobile station device 200-1 includes the channel H₁₁ between the mobile station device 200-1 and the base station device 100-1 cooperating therewith, the channel H₁₂ between the mobile station device 200-1 and the base station device 100-2 cooperating therewith, and the channel H₁₃ between the mobile station device 200-1 and the base station device 100-3 cooperating therewith.

Further, the control signal generation unit 221 generates a control signal containing downlink information about a parameter of a transmission signal (CQI, RI, other information about scheduling, and the like). The downlink information about the parameter of the transmission signal is determined based on the channel estimated value which is calculated by the higher layer 213, in channel estimation unit 206.

Further, the control signal generation unit 221 generates a control signal by performing an error correction coding and a modulation mapping on the control data. In the transmission unit 222, a signal containing the control signal output by the control signal generation unit 221 is up-converted into a frequency band signal in which transmission is possible in downlink, and is transmitted to the base station device 100-j connected thereto, through the transmission antenna unit 223.

Next, the process of the interference suppression unit 207 in the mobile station device 200-k will be described specifically. Hereinafter, a case where the number of antennas of the mobile station is two (e=2) will be described.

In the mobile station device 200-k, if the signal which is input to the interference suppression unit 207 from the DFT unit 205-1 and the DFT unit 205-2 is assumed as Rₖ, it is possible to represent Rₖ as follows, by using Equation (5).

$$\begin{matrix}[ Equation 5 ] & \\ {R}_{k} = {H}_{k} V ⊕ S \\ {R}_{k} = [ \begin{matrix}{R}_{k , 1} \\ {R}_{k , 2}\end{matrix} ] \\ {H}_{k} = [ \begin{matrix}{H}_{k 1 , 1} & {H}_{k 2 , 1} & {H}_{k 3 , 1} \\ {H}_{k 1 , 2} & {H}_{k 2 , 2} & {H}_{k 3 , 2}\end{matrix} ] \\ V = [ \begin{matrix}{V}_{1} \\ {V}_{2} \\ {V}_{3}\end{matrix} ] \\ S = [ \begin{matrix}{S}_{1} \\ {S}_{2} \\ {S}_{3}\end{matrix} ] & ( 5 )\end{matrix}$$

⊕ means addition of respective elements

Here, R_{k,e} is a signal which is input from the DFT unit 205-e of the mobile station device k, H_{kj,e} is a channel (transfer function) in a case where the mobile station device 200-k receives the transmission signal of the base station device 100-j (j=1 to 3) through the reception antenna unit 201-e, Vⱼ is a transmission weight coefficient which is multiplied by the transmission signal of the base station device 100-j (multiplied in the pre-coding unit 104 of each base station device), and Sⱼ is the data modulation symbol of the base station device 100-j.

Further, if a signal obtained by the interference suppression unit 207 multiplying Rₖ with the reception weight coefficient Uₖ as Yₖ, Equation (6) is represented. Here, U_{k,e} is the reception weight coefficient which is multiplied by the signal input from the DFT unit 205-e of the mobile station device 200-k.

[Equation 6]

Yₖ=UₖR=UₖHₖV⊕S

Uₖ=[U_{k,1}U_{k,2}] (6)

[Uplink Transmission Format of Communication System]

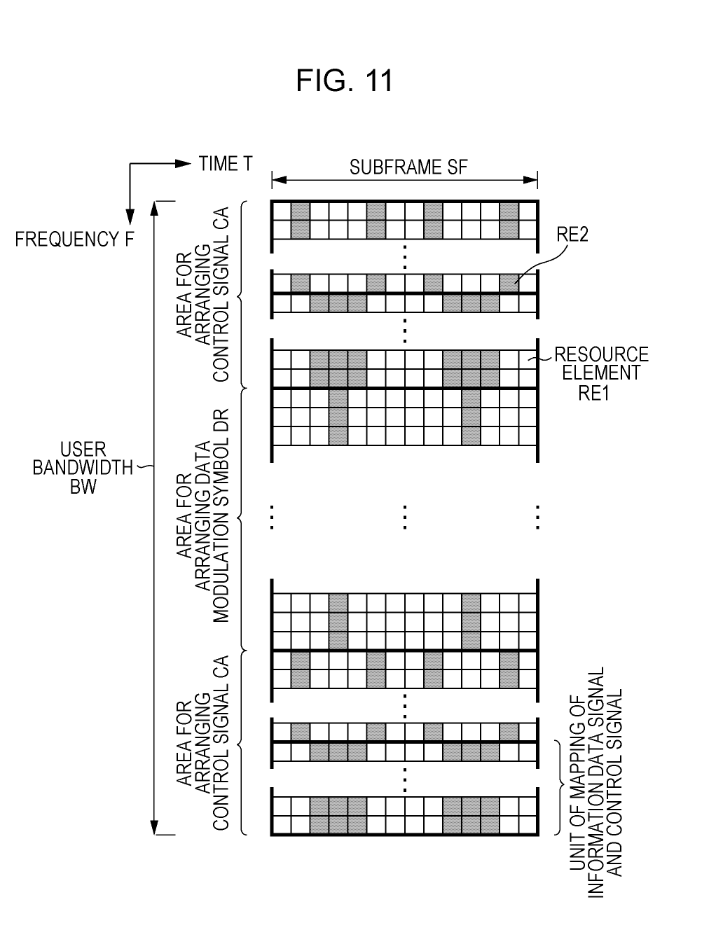

FIG. 11 is an example of a frame format of all signals that are transmitted to the base station device by the mobile station device. In FIG. 11, the horizontal axis represents a time T, and the vertical axis represents a frequency F.

A white part RE1 is a resource element to which the control signal and the information data signal (data modulation symbol) are mapped. Further, a bandwidth (user bandwidth BW) allocated for the transmission by the mobile station device is divided into a placement area CA for arranging the control signal, and an area DR for arranging the information data.

Further, a solid part RE2 is a resource element for mapping the reference signal.

The control signal generation unit 221 of FIG. 7 mapping the control signal containing the feedback information and the like to the control signal placement area CA, based on the formats of all transmission signals of FIG. 11. Such a control signal and the like are mapped in a predetermined unit (for example, a resource block unit in Embodiment 1).

Further, the control signal generation unit 221 maps the control signal to the control signal placement area CA, based on a predetermined control signal format.

In the communication system of the present embodiment, the transmission and reception weight coefficients for realizing cooperative communication are calculated. In the communication system of the present embodiment, a plurality of types of control signal formats are included, and at least one of the control signal formats includes a control signal format having an area for storing feedback information used in the transmission and reception weight coefficient calculation. Further, at least one of the control signal formats having the area for storing feedback information used in the transmission and reception weight coefficient calculation includes a control signal format in which the numbers of OFDM symbols are different in an area for storing the channel information between the mobile station device and the base station device connected to the mobile station device and an area for storing the channel information between the mobile station device and the base station device other than the base station device connected to the mobile station device.

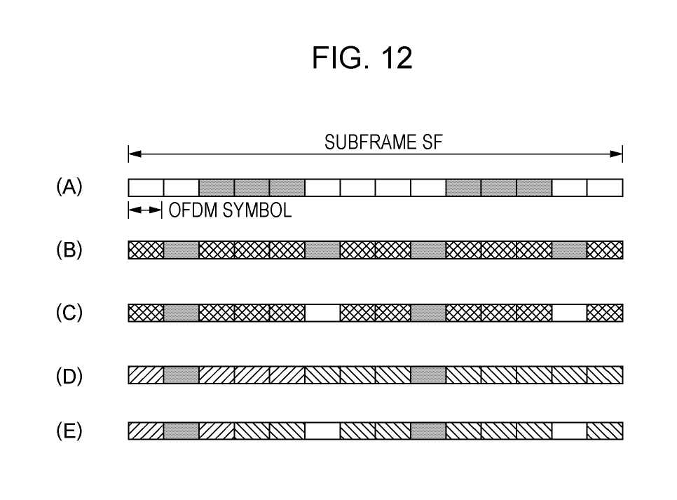

FIG. 12 is an example of a control signal format of a control signal placement area of an uplink frame format.

In FIG. 12, a solid part is an OFDM symbol to which a reference signal is allocated. Further, a white part is an OFDM symbol allocated for notifying ACK/NACK for downlink data. Further, a diagonal cross-hatched part is an OFDM symbol allocated for notifying downlink channel quality (CQI). Further, a forward diagonally hatched part and a backward diagonally hatched part are OFDM symbols allocated for feedback of channel information between the mobile station device and the base station device.

One of the forward diagonally hatched part and the backward diagonally hatched part is an OFDM symbol to which the channel information between the mobile station device and the base station device connected to the mobile station device is allocation, and the other is an OFDM symbol to which the channel information between the mobile station device and the base station device other than the base station device connected to the mobile station device is allocated.

FIG. 12 illustrates five types of control signal formats (FIG. 12(A) to FIG. 12(E)). Among these, FIG. 12(D) and FIG. 12(E) are control signal formats having an area for storing the feedback information used for calculating the transmission and reception weight coefficients.

Further, FIG. 12(E) is an OFDM symbol including a control signal format having different numbers of OFDM symbols in an area for storing the channel information between the mobile station device and the base station device connected to the mobile station device and an area for storing the channel information between the mobile station device and the base station device other than the base station device connected to the mobile station device.

For example, when the feedback information generation unit 208 further reduces the number of quantization bits of the channel information between the mobile station device and the base station device connected to the mobile station device than the number of quantization bits of the channel information between the mobile station device and the base station device other than the base station device connected to the mobile station device, the control signal generation unit 221 allocates each signal according to FIG. 12(E). In other words, the feedback information about the channel information between the mobile station device and the base station device connected to the mobile station device is allocated to the OFDM symbol of the right diagonal line, and the feedback information about the channel information between the mobile station device and the base station device other than the base station device connected to the mobile station device is allocated to the OFDM symbol of the left diagonal line.

In addition, it is possible to apply a different number of modulation levels to the signals assigned to respective OFDM symbols of FIG. 12 or to multiply the signals assigned to respective OFDM symbols by spread codes of different spreading factors. Thus, it is possible to finely adjust the allocation of the feedback information.

In addition, FIG. 12 illustrates control signal formats for ACK/NACK notification, CQI notification, channel information notification, but may include control signal formats for other types of uplink control information (for example, an HARQ, a scheduling report, and the like).

[Overall Operation of Communication System]

Next, a procedure between the base station device and the mobile station device in the communication system will be explained.

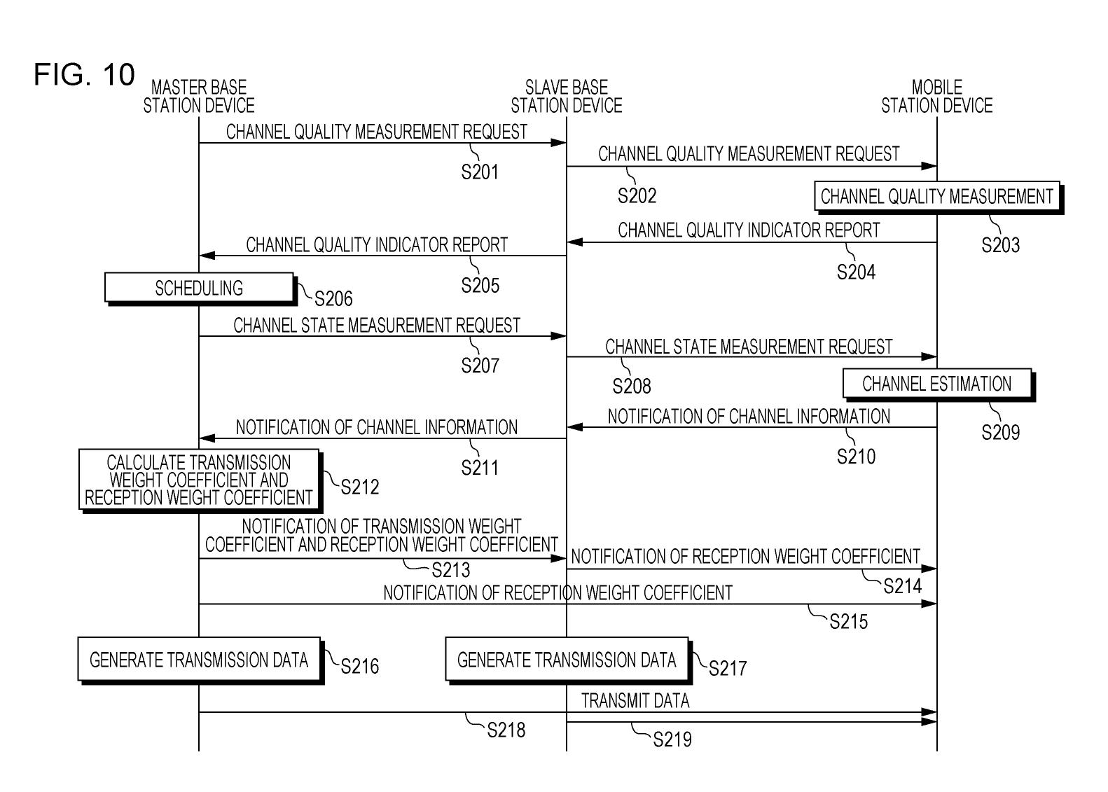

FIG. 10 is a sequence diagram illustrating an operation example in which the master base station device (base station device 100-1) of the communication system calculates the transmission weight coefficient Vⱼ and the reception weight coefficient Uₖ, and notifies the slave base station device (base station devices 100-2 and 100-3) and the mobile station device 200-k of the calculated coefficients.

The master base station device makes a request for channel quality measurement to the slave base station device (S201). The channel quality measurement request may be periodic or non-periodic.

Further, each slave base station device makes a request for the channel quality measurement to the mobile station device connected to its own station (S202). The channel quality measurement request may be periodic or non-periodic.

Meanwhile, the mobile station device connected to the master base station device receives the channel quality measurement request directly from the master base station device.

Next, the mobile station device 200-k which receives the channel quality measurement request measures (estimates) the channel between the mobile station device and the base station device (S203). The mobile station device 200-k measures a channel by using the reference signal transmitted by each base station device (S203). For example, in FIG. 9, the mobile station device 200-k measures a channel by using the first reference signal. The channel estimation unit 206 can perform the measurement of a channel.

Further, the mobile station device 200-k generates a channel quality indicator report based on the channel measurement result, and notifies the base station device connected to its own mobile station device of the channel quality indicator report (S204).

The channel quality indicator report corresponds to, for example, downlink information about a parameter of a transmission signal (CQI, RI, other information about downlink scheduling, and the like). The generation of the channel quality indicator report can be performed by the higher layer 213.

Then, the slave base station device that has received the channel quality indicator report notifies the master base station device of the channel quality indicator report (S205).

Next, the master base station device performs scheduling between the base station device and the mobile station device which are to cooperatively communicate with each other, taking into account the channel quality indicator report (S206).

Then, the master base station device makes a request for channel state measurement of a resource, in which each mobile station device is scheduled, to the slave base station device which is determined as the cooperative base station device (S207). The request can be performed by using a backhaul.

Further, each slave base station device makes a channel quality measurement request to the mobile station device connected to its own station (S208).

Next, if the channel quality measurement request is received, the mobile station device performs the channel estimation (S209). The channel estimation unit 206 performs channel estimation, by using the first reference signal or the second reference signal (S209). Further, the mobile station device generates feedback information from the channel estimated value (for example, S209 in FIG. 8), and notifies the base station device connected to its own mobile station device of such information (S210). Further, the slave base station device notifies the master base station device of the feedback information (S211).

In addition, the mobile station device connected to the master base station device directly notifies the master base station device of the feedback information.

Next, the master base station device calculates a transmission weight coefficient Vj and a reception weight coefficient Uₖ, based on the feedback information (channel information) obtained in step S211 (S212).

Then, the master base station device notifies the slave base station device 100-j of the calculated transmission weight coefficient Vⱼ (S213). The notification can be performed by using the backhaul. Further, the master base station device notifies each mobile station device of the reception weight coefficient Uₖ of the mobile station device through the base station device connected to each mobile station device (S213 and S214).

For example, the mobile station device 200-2 connected to the slave base station device 100-2 acquires the reception weight coefficient U₂ from the master base station device 100-1, through the slave base station device 100-2.

In addition, the master base station device directly notifies the mobile station device of the reception weight coefficient U₁ of the mobile station device 200-1 connected to its own station (S215).

Next, the master base station device and the slave base station device multiplies the information data to be transmitted to the mobile station device connected to its own station by the transmission weight coefficient Vⱼ (S216, and S217), and transmits the result information data (S218, and S219).

As described above, in the first embodiment, in a wireless communication system in which a base station device and a mobile station device cooperatively communicate with each other, the base station device can calculate the transmission and reception weight coefficients for realizing the cooperative communication, by using the feedback information having different number of bits. Specifically, among the channel information between the mobile station device and the base station device connected to the mobile station device and the channel information between the mobile station device and the base station device other than the base station device connected to the mobile station device, the number of bits of one type of channel information can be adjusted so as to be further reduced than the number of bits of the other type of channel information.

Thus, the mobile station device can reduce the amount of the feedback information to be transmitted to the base station device.

### Second Embodiment

A second embodiment relates to a format of channel information that is fed back to the base station device by the mobile station device, in the communication system described in the first embodiment in which the plurality of base station devices 100-j and mobile station device 200-k cooperate with each other so as to suppress the inter-cell interference.

In the communication system of the present embodiment, a plurality of types of control signal formats are included, and at least two of the control signal formats include a control signal format having an area for storing feedback information used in the calculation of the transmission and reception weight coefficients.

Further, the control signal format having an area for storing the feedback information used for calculating the transmission and reception weight coefficients includes a control signal format having different numbers of OFDM symbols.

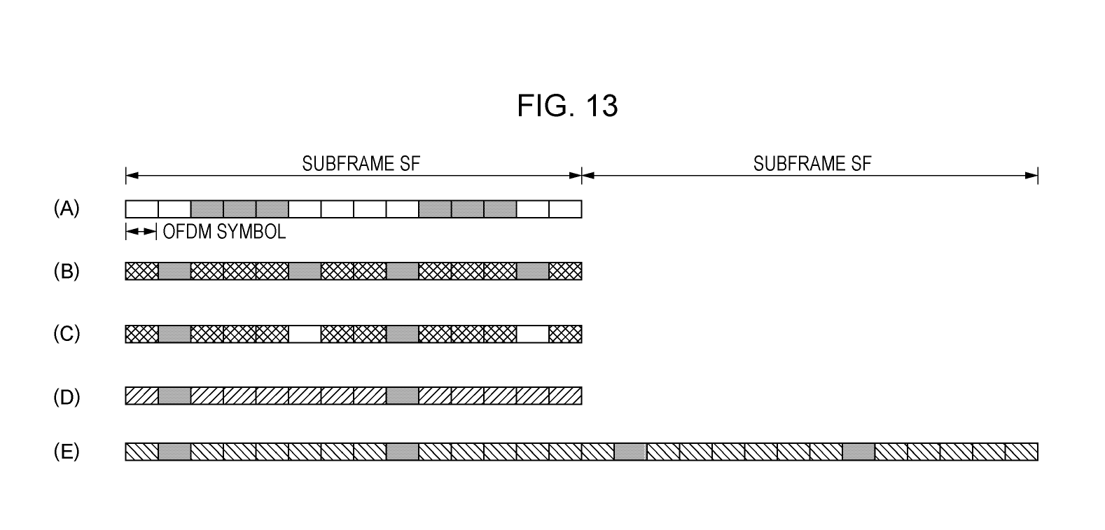

FIG. 13 is an example of a control signal format of a control signal placement area of an uplink frame format of the second embodiment.

FIG. 13 is an example in which a control signal format having different numbers of OFDM symbols is included, in the control signal format having an area for storing the feedback information used for calculating the transmission and reception weight coefficients.

In FIG. 13, a solid part is an OFDM symbol to which a reference signal is allocated. Further, a white part is an OFDM symbol allocated for notifying an ACK/NACK for the downlink data. Further, a diagonal cross-hatched part is an OFDM symbol allocated for notifying a downlink channel quality (CQI). Further, a forward diagonally hatched part and a backward diagonally hatched part are OFDM symbols allocated for feeding back the channel information between the mobile station device and the base station device.

One of the forward diagonally hatched part and the backward diagonally hatched part is an OFDM symbol to which the channel information between the mobile station device and the base station device connected to the mobile station device is allocated, and the other is an OFDM symbol to which the channel information between the mobile station device and the base station device other than the base station device connected to the mobile station device is allocated.

FIG. 13 illustrates a case where five types of control signal formats are defined (FIG. 13(A) to FIG. 13(E)). Among these, FIG. 13(D) and FIG. 13(E) are control signal formats having an area for storing feedback information used for calculating the transmission and reception weight coefficients.

Further, in the control signal formats of FIG. 13, a control signal format (FIG. 13(E)) having a larger number of OFDM symbols for storing the feedback information than a control signal format of FIG. 13(D) is defined.

For example, when the feedback information generation unit 208 further reduces the number of quantization bits of the channel information between the mobile station device and the base station device connected to the mobile station device than the number of quantization bits of the channel information between the mobile station device and the base station device other than the base station device connected to the mobile station device, with respect to feedback information about the channel information between the mobile station device and the base station device connected to the mobile station device, the control signal generation unit 221 allocates the feedback information to the OFDM symbol, based on the format of FIG. 13(D). Meanwhile, with respect to feedback information about the channel information between the mobile station device and the base station device other than the base station device connected to the mobile station device, the control signal generation unit 221 allocates the feedback information to the OFDM symbol, based on the format of FIG. 13(E).

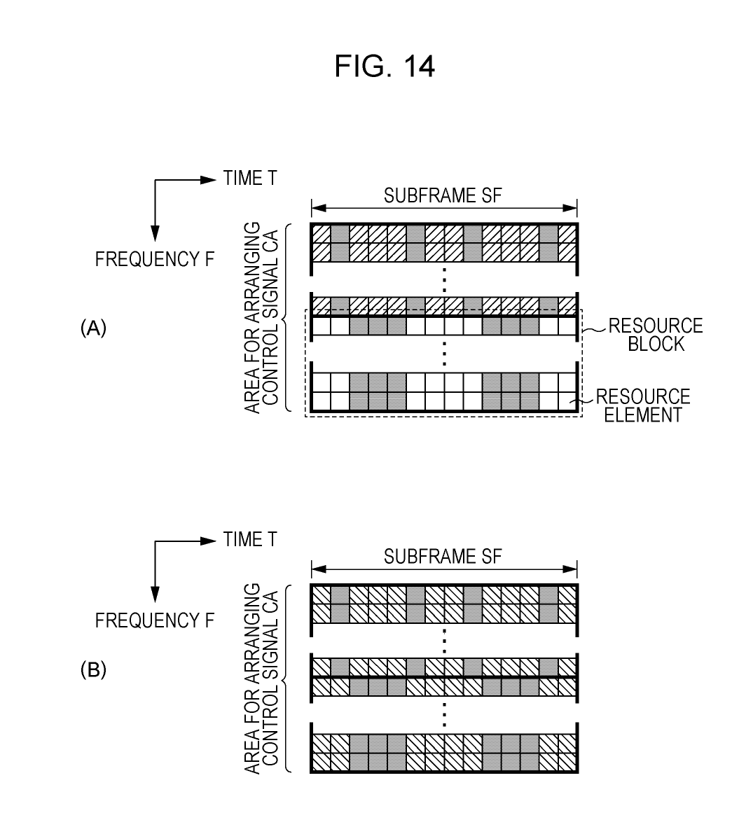

FIG. 14 is another example of the control signal format of the control signal placement area of the uplink frame format of the second embodiment. FIG. 14 is an example in which a control signal format having different numbers of subcarriers is included, in the control signal format having an area for storing the feedback information used for calculating the transmission and reception weight coefficients.

In FIG. 14, a solid part is an OFDM symbol to which a reference signal is allocated. Further, a white part is an OFDM symbol allocated for notifying an ACK/NACK for the downlink data. Further, a forward diagonally hatched part and a backward diagonally hatched part are OFDM symbols allocated for feeding back the channel information between the mobile station device and the base station device.

One of the forward diagonally hatched part and the backward diagonally hatched part is an OFDM symbol to which the channel information between the mobile station device and the base station device connected to the mobile station device is allocated, and the other is an OFDM symbol to which the channel information between the mobile station device and the base station device other than the base station device connected to the mobile station device is allocated.

Further, in the control signal formats of FIG. 14, a control signal format (FIG. 14(B)) having a larger number of subcarriers for storing the feedback information than a control signal format of FIG. 14(A) is defined.

Further, in the control signal formats of FIG. 14, it is considered that a control signal format (FIG. 14(B)) having a larger number of resource blocks for storing the feedback information than a control signal format of FIG. 14(A) is defined.

For example, when the feedback information generation unit 208 further reduces the number of bits of the channel information between the mobile station device and the base station device connected to the mobile station device than the number of bits of the channel information between the mobile station device and the base station device other than the base station device connected to the mobile station device, with respect to feedback information about the channel information between the mobile station device and the base station device connected to the mobile station device, the control signal generation unit 221 allocates the feedback information to the resource element, based on the format of FIG. 14(A). Meanwhile, with respect to feedback information about the channel information between the mobile station device and the base station device other than the base station device connected to the mobile station device, the control signal generation unit 221 allocates the feedback information to the resource element, based on the format of FIG. 14(B).

As described above, in the second embodiment, in a wireless communication system in which a base station device and a mobile station device cooperatively communicate with each other, the base station device can calculate the transmission and reception weight coefficients for realizing the cooperative communication, by using the channel information having different number of bits. Then, the communication system of the present embodiment includes a control signal format having an area for feed backing the channel information. The control signal format includes formats having different numbers of OFDM symbols and subcarriers.

Then, among the channel information between the mobile station device and the base station device connected to the mobile station device and the channel information between the mobile station device and the base station device other than the base station device connected to the mobile station device, the number of bits of one type of channel information is adjusted so as to be further reduced than the number of bits of the other type of channel information. Then, the control signal format for feeding back the channel information is allocated, based on the number of bits.

Thus, it is effective because it is possible to reduce the amount of feedback information while suppressing the reduction of the interference suppression function of the communication system.

In addition, it is possible to use both the control signal format of FIG. 13 and the control signal format of FIG. 14.

In addition, it is possible to apply a different number of modulation levels to the signals assigned to respective OFDM symbols of FIGS. 13 and 14 or to multiply the signals assigned to respective OFDM symbols by spread codes of different spreading factors. Thus, it is possible to finely adjust the allocation of the feedback information.

In addition, FIGS. 13 and 14 illustrate the control signal formats for the ACK/NACK notification, the CQI notification, and the channel information notification, but may include control signal formats for the other uplink control information (for example, HARQ, a scheduling report, and the like).

### Third Embodiment

A third embodiment relates to a function of adjusting the amount of feedback information used for calculating transmission and reception weight coefficients in order for the mobile station device realizes cooperative communication, in the communication system described in the first embodiment in which the plurality of base station devices 100-j and mobile station device 200-k cooperate with each other so as to suppress the inter-cell interference.

The feedback information generation unit 208 generates feedback information depending on each base station device, by using the channel estimated value which is input from the channel estimation unit 206.

The feedback information generation unit 208 of the present embodiment has a function of adjusting the feedback information amount depending on each base station device, by performing a compression process on the channel estimated value.

Specifically, it is possible to perform the compression process on any one type of channel information, among the channel information between the mobile station device and the base station device connected to the mobile station device and the channel information between the mobile station device and the base station device other than the base station device connected to the mobile station device.

Otherwise, among the channel information between the mobile station device and the base station device connected to the mobile station device and the channel information between the mobile station device and the base station device other than the base station device connected to the mobile station device, the compression ratio of the feedback information amount of one type of channel information is set to be greater than the compression ratio of the feedback information amount of the other type of channel information.

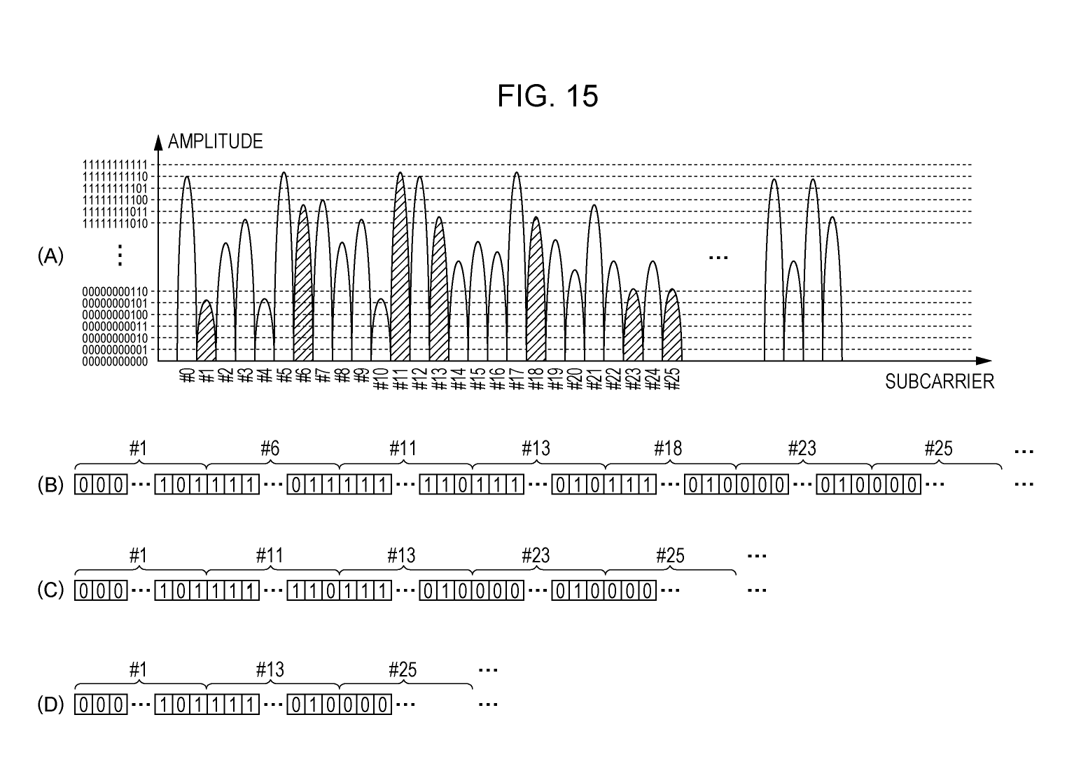

FIG. 15 illustrates an aspect of generating feedback information from a channel estimated value by a compression process. FIG. 15(A) illustrates amplitudes of respective subcarriers after a reception signal is converted from a time domain signal to a frequency domain signal by the DFT unit 205. The horizontal axis represents a subcarrier index, and a vertical axis represents amplitude. In FIG. 15(A), the amplitude is quantized to 12 bits.

In FIG. 15(A), the hatched parts are subcarriers in which the reference signals transmitted by the base station devices are mapped.

The channel estimation unit 206 performs channel estimation, by calculating the amplitude and phase (channel information) of the subcarrier in which the reference signal is mapped.

Then, the channel estimation unit 206 inputs the amplitude and phase of the subcarrier to the feedback information generation unit 208.

FIG. 15(B) is an example of a bit sequence of subcarrier amplitude which is input to the feedback information generation unit 208 by the channel estimation unit 206.

FIG. 15(C) and FIG. 15(D) are cases where compression is performed by thinning out the subcarriers for generating feedback information.

FIG. 15(C) is an example of a case of compressing the bit sequence of FIG. 15(B) to ⅔.

FIG. 15(D) is an example of a case of compressing the bit sequence of FIG. 15(B) to ⅓.

Next, the feedback information generation unit 208 generates feedback information by performing a compression process on the bit sequence of the amplitude and phase of the subcarrier which is input from the channel estimation unit 206. Hereinafter, the compression process of the present embodiment will be described with the case of further reducing the feedback information amount between the mobile station device and base station device connected to the mobile station device than the feedback information amount between the mobile station device and the base station device other than the base station device connected to the mobile station device as an example.

It is assumed that the feedback information generation unit 208 recognizes the reference signal as the reference signal transmitted by the base station device other than the base station device connected to the mobile station device.

In such a case, the feedback information generation unit 208 generates feedback information, without performing a compression process (compression rate 1). In other words, the feedback information generation unit 208 outputs the sequence of the same number of bits as that of the input bit sequence (FIG. 15(B)).

Meanwhile, it is assumed that the feedback information generation unit 208 recognizes the reference signal as the reference signal transmitted by the base station device connected to the mobile station device.

In such a case, the feedback information generation unit 208 generates feedback information by performing the compression process. Then, the feedback information generation unit 208 outputs the compressed bit sequence (FIG. 15(C), or FIG. 15(D)).

The feedback information generation unit 208 changes the compression rate by the transmission source of the reference signal, as another compression process.

For example, it is assumed that the feedback information generation unit 208 recognizes the reference signal as the reference signal transmitted by the base station device other than the base station device connected to the mobile station device.

In such a case, the feedback information generation unit 208 generates feedback information by performing a compression process at a compression rate of ⅔, and outputs the compressed bit sequence (FIG. 15(C)).

Meanwhile, it is assumed that the feedback information generation unit 208 recognizes the reference signal as the reference signal transmitted by the base station device connected to the mobile station device. In such a case, the feedback information generation unit 208 generates feedback information by performing a compression process at a compression rate of ⅓, and outputs the compressed bit sequence (FIG. 15(D)).

As described above, in the third embodiment, in a wireless communication system in which a base station device and a mobile station device cooperatively communicate with each other, the base station device can calculate the transmission and reception weight coefficients for realizing the cooperative communication, by using the feedback information having different number of bits. Specifically, among the channel information between the mobile station device and the base station device connected to the mobile station device and the channel information between the mobile station device and the base station device other than the base station device connected to the mobile station device, the compression rate of one type of channel information is set to be greater than the compression rate of the other type of channel information.

Thus, it is possible for the mobile station device to reduce the amount of feedback information transmitted to the base station device while suppressing the reduction of the interference suppression capability.

In addition, in the present embodiment, the compression process is performed by thinning out the subcarrier for generating feedback information, but as long as a compression process can reduce the number of bits of feedback information, it is possible to achieve the effects of the present embodiment. For example, in a method of compression by converting information into information in the time domain, which will be described later, it is possible to achieve the same effect by changing the number of quantization bits, depending on a base station device which transmits a signal.

### Fourth Embodiment

The fourth embodiment is an aspect in which feedback information is generated from a channel estimated value by a compression process different from the third embodiment. In the embodiment, feedback information is generated by converting the channel estimated value (channel information) for each subcarrier into information in the time axis. Thus, the feedback information amount is adjusted depending on each base station device.

Specifically, among the channel information between the mobile station device and the base station device connected to the mobile station device and the channel information between the mobile station device and the base station device other than the base station device connected to the mobile station device, one type of channel information is subjected to the compression process in the frequency domain, and the other type of channel information is converted into information in the time domain and is subjected to the compression process.

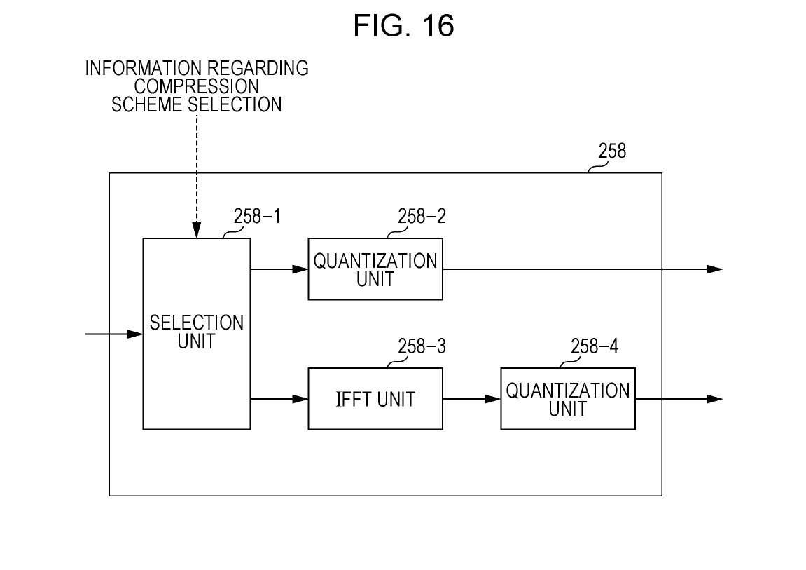

In the present embodiment, the feedback information generation unit 208 of the third embodiment is realized by replacing it with the feedback information generation unit 258 (FIG. 16). Hereinafter, components different from the third embodiment will be described.

[Mobile Station Device]

FIG. 16 is a feedback information generation unit 258 of the fourth embodiment. The feedback information generation unit 258 is configured to include a selection unit 258-1, a quantization unit 258-2, an IFFT unit 258-3, and a quantization unit 258-4.

The selection unit 258-1 inputs the channel information which is input from the channel estimation unit 206 to the quantization unit 258-2 or the IFFT unit 258-3, based on information about selection of a compression method which is input from the higher layer 213.

The quantization unit 258-2 is selected in a case of compressing the channel information in the frequency domain. The quantization unit 258-2 has a function described in FIG. 15.

The IFFT unit 258-3 and the quantization unit 258-4 are selected when the channel information is converted into information in the time domain and compressed. In such a case, the amplitude and phase of the subcarrier which are quantized are feedback information. For example, when the number of subcarriers of OFDM is 1200, 1200×12 bits are information amount of feedback information.

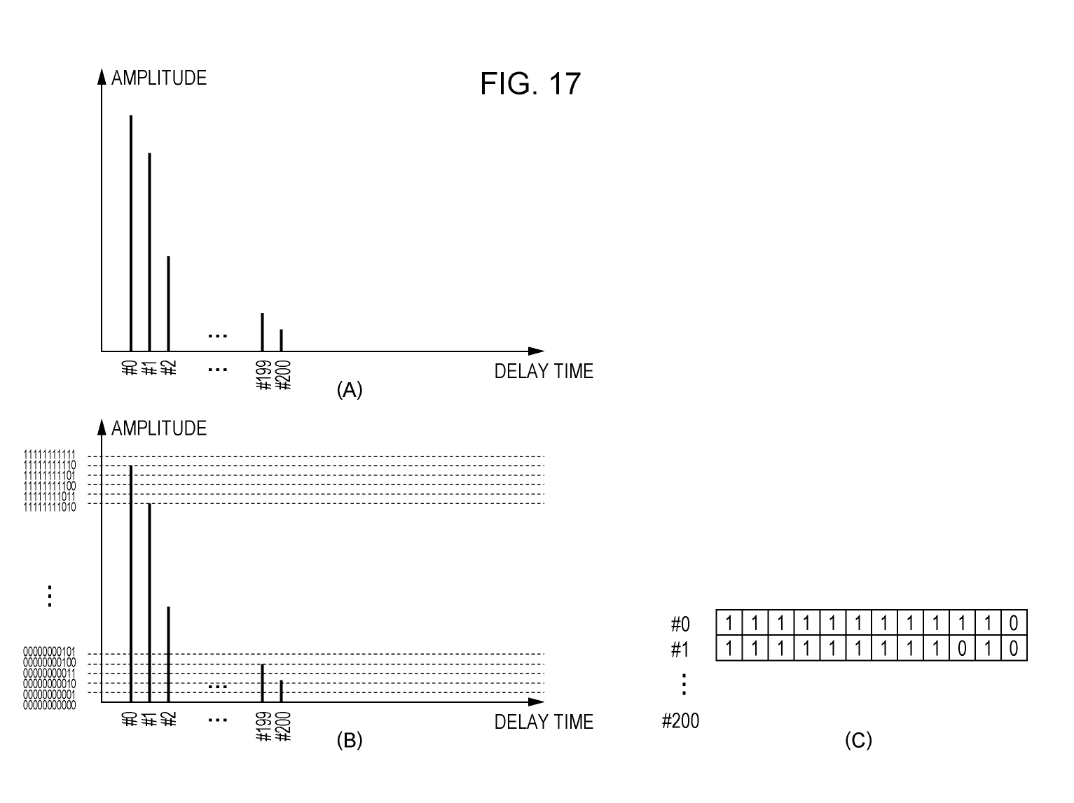

FIG. 17 is an aspect of a method of compressing the channel information by converting it into time domain information. The IFFT unit 258-3 generates an impulse response by performing inverse fast Fourier transform (IFFT) on the input channel estimated value. FIG. 17(A) illustrates the impulse response in a case of performing the inverse fast Fourier transform on the channel estimated value which is input from the selection unit 258-1.

FIG. 17(A) is a case where the maximum delay time of the impulse response is 200 samples, and filtering is performed by assuming the impulse response of the length of 200 samples, but the number of samples may be the number of samples of a GI length, or may be a maximum delay time of a path including a path energy greater than a threshold.

Next, the quantization unit 258-4 quantizes an impulse response (amplitude and phase) which is input from the IFFT unit 258-3. FIG. 17(B) is an example where the impulse response is quantized into 12 bits in the quantization unit 258-4. In such a case, the path 0 to the path 200 which are quantized (FIG. 15(C)) are feedback information. For example, when the number of paths is 200, 200×12 bits are the information amount of the feedback information.

For example, it is assumed that the selection unit 258-1 receives a notification indicating that the signal transmitted by the base station device other than the base station device connected to the mobile station device is compressed in the frequency domain, and receives a notification indicating that the signal transmitted by the base station device connected to the mobile station device is converted into a signal in the time domain, and is compressed, as information about the selection of a compression method. In such a case, the signal transmitted by the base station device other than the base station device connected to the mobile station device is input to the quantization unit 258-2. Meanwhile, the signal transmitted by the base station device connected to the mobile station device is input to the IFFT unit 258-3.

Further, the mobile station device receives notification of control information indicating whether compression is performed in the frequency domain, or compression is performed in the time domain after conversion, from the base station device (the master base station device or the slave base station device). Such control information can be notified in a channel statement measurement request S207 in FIG. 10.

For example, the master base station device and the slave base station device notify of compressing the reference signal transmitted by the base station device connected to the mobile station device in the time domain after conversion, and compressing the reference signal transmitted by the base station device other than the base station device connected to the mobile station device in the frequency domain signal after conversion.

[Base Station Device (Master Base Station Device and Slave Base Station Device)]

When receiving the channel information subjected to converted and compressed in the time domain, the higher layer 101 of the master base station device and the higher layer 151 of the slave base station device perform fast Fourier transform (FFT) on the channel information subjected to converted and compressed in the time domain, and convert the channel information into channel information for each subcarrier. For example, an impulse response (FIG. 15(B)) from the notified channel information (FIG. 15(C)) is generated.

As described above, in the fourth embodiment, in a wireless communication system in which a base station device and a mobile station device cooperatively communicate with each other, the base station device can calculate the transmission and reception weight coefficients for realizing the cooperative communication, by using the feedback information having different number of bits. Specifically, among the channel information between the mobile station device and the base station device connected to the mobile station device and the channel information between the mobile station device and the base station device other than the base station device connected to the mobile station device, feedback information for one type of channel information is generated in the frequency domain, and feedback information for the other type of channel information is generated in the time domain.

Thus, the mobile station device can reduce the amount of feedback information transmitted to the base station device.

In addition, the control information indicating whether compression is performed in the frequency domain or compression is performed in the time domain after conversion can be notified in the channel quality measurement request S201 in FIG. 10. Thus, it is possible to achieve an effect of reducing the information amount of the channel quality indicator reports S204 and S205 in the system.

### Fifth Embodiment

A fifth embodiment is a case where feedback information is notified based on a sequence different from the first embodiment. In the present embodiment, the mobile station device calculates the channel information used in the weight coefficient calculation collectively with the channel quality measurement, and notifies the base station device of the channel information.

Hereinafter, the components different from the first embodiment will be described.

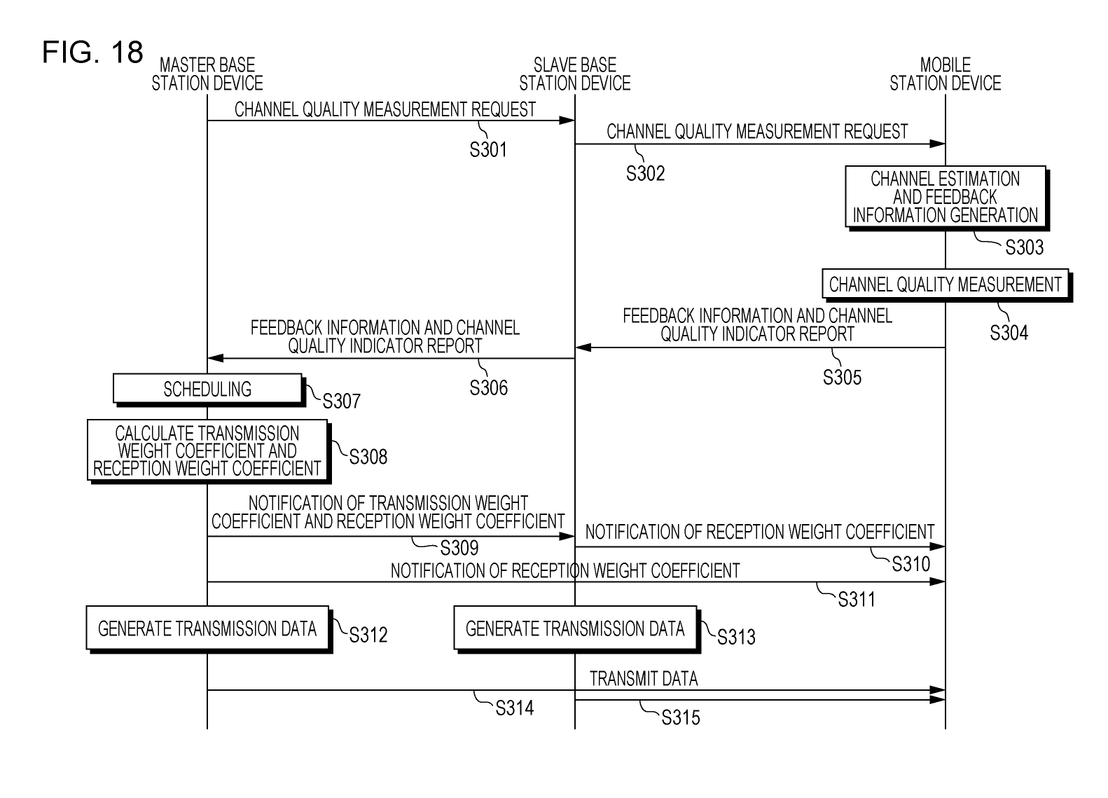

FIG. 18 is a sequence diagram illustrating an operation example in which a master base station device (base station device 100-1) of a communication system according to a fifth embodiment calculates the transmission weight coefficient Vⱼ and the reception weight coefficient Uₖ, and notifies the slave base station devices (the base station devices 100-2 and 100-3) and the mobile station device 200-k of the coefficients.

The master base station device makes a channel quality measurement request to the slave base station device (S301). Further, each slave base station device makes a channel quality measurement request to the mobile station device connected to the slave base station device (S302).

Meanwhile, the mobile station device connected to the master base station device directly receives the channel quality measurement request from the master base station device.

Next, the mobile station device 200-k that has received e the channel quality measurement request estimates a channel between the mobile station device and the base station device (S303). The mobile station device 200-k performs channel estimation, by using the reproduced sound transmitted by each base station device (S303). For example, in FIG. 9, a channel is estimated by using the first reference signal. The estimation of the channel can be performed by the channel estimation unit 206.

The mobile station device 200-k generates feedback information from the channel estimated value (for example, S303 in FIG. 8).

Further, the mobile station device 200-k generates a channel quality indicator report, based on the channel measurement result (S304). The channel quality indicator report corresponds to, for example, the downlink information (CQI, RI, information about the other downlink scheduling, and the like) about the parameters of the transmission signal. The generation of the channel quality indicator report can be performed by the higher layer 213.

Then, the mobile station device 200-k notifies the feedback information and the channel quality indicator report to the base station device to which the mobile station device is connected (S305). In addition, the slave base station device which receives the channel quality indicator report notifies the channel quality indicator report to the master base station device (S306).

Next, the master base station device performs scheduling between the base station device and the mobile station device which are subjects of the cooperative communication, with consideration of the channel quality indicator report (S307). Then, the master base station device calculates the transmission weight coefficient Vⱼ and the reception weight coefficient Uₖ, for the slave base station device determined as the base station device to perform cooperation, based on the feedback information acquired in step 305 (S308).

Then, the master base station device notifies the slave base station device 100-j of the calculated transmission weight coefficient Vⱼ (S309). The notification can be performed by using the backhaul. Further, the master base station device notifies the reception weight coefficient Uₖ of each mobile station device through the base station device connected to each mobile station device (S309, and S310).

For example, the mobile station device 200-2 connected to the slave base station device 100-2 acquires the reception weight coefficient U₂ from the master base station device 100-1, through the slave base station device 100-2.

In addition, the master base station device directly notifies the mobile station device of the reception weight coefficient U₁ of the mobile station device 200-1 connected to the master base station device (S311).

Next, the master base station device or the slave base station device multiplies information data to be transmitted to the mobile station device connected to the master base station device or the slave base station device by the transmission weight coefficient Vⱼ (S312 and S313), and transmits the multiplied information data (S314 and S315).

As described above, in the fifth embodiment, in a wireless communication system in which the base station device and the mobile station device perform cooperative communication, the mobile station device can calculate the feedback information having different numbers of bits by using the first reference signal. Thus, the mobile station device can calculate the feedback information from the channel estimated value of a wide bandwidth.

Further, in the fifth embodiment, in a wireless communication system in which a base station device and a mobile station device cooperatively communicate, the mobile station device can generate feedback information based on a channel quality indicator report. Thus, it is possible to shorten the time until the transmission and reception weight coefficients are calculated.

Further, among the channel information between the mobile station device and the base station device connected to the mobile station device and the channel information between the mobile station device and the base station device other than the base station device connected to the mobile station device, the number of bits of one type of channel information is adjusted so as to be less than the number of bits of the other type of channel information. Thus, the mobile station device can reduce the amount of feedback information to be transmitted to the base station device.

Further, a program operating in the mobile station device and the base station device according to the present invention is a program for controlling the CPU and the like in order to realize a function of the embodiment according to the present invention (a program for causing a computer to execute the function). Then, the information handled by these devices is stored in the RAM temporarily during the process, and thereafter is stored in various ROMs and a HDD, and read by the CPU as necessary, and modification and writing are performed. Examples of a recording medium for storing a program may be any of semiconductor media (for example, a ROM, a nonvolatile memory card, or the like), optical recording media (for example, a DVD, a MO, a MD, a CD, a BD, or the like), magnetic recording media (for example, a magnetic tape, a flexible disk, or the like), and the like. Further, the functions of the above-described embodiments are realized by executing the loaded program, and the functions of the invention may be implemented by performing processes in association with an operating system or another application program based on an instruction of the program.

Further, when it is distributed in markets, it is possible to distribute the program by being stored in a portable recording medium, or to transfer the program to a server computer connected through a network such as the Internet. In this case, the storage device of the server computer is also included in the present invention. Further, part or all of the mobile station device and the base station device in the embodiment described above may be implemented as an LSI which is typical integrated circuit. The functional blocks of the receiver may be made into individual chips, or part or all may be integrated and made into chips. When the respective functional blocks are made into an integrated circuit, an integrated circuit control unit that controls them is added.

Further, the circuit integration method is not limited to the LSI, but may be implemented by a dedicated circuit or a general-purpose processor. Further, when a circuit integration technology to replace LSI as a result of advances in a semiconductor technology have emerged, the use of an integrated circuit according to the technology is also possible.

Hitherto, the embodiments of the invention has been described in detail with reference to the drawings, but the specific configuration is not limited to the embodiments, and the design and the like without departing from the scope of the invention also is included within the scope of the claims.

### REFERENCE SIGNS LIST

10 BACKHAUL
100 BASE STATION DEVICE
100-1 MASTER BASE STATION DEVICE
100-2, 100-3 SLAVE BASE STATION DEVICE
101 HIGHER LAYER
102 CODING UNIT
103 MODULATION UNIT
104 PRE-CODING UNIT
105 WEIGHT COEFFICIENT CONTROL UNIT
106 REFERENCE SIGNAL GENERATION UNIT
107 CONTROL SIGNAL GENERATION UNIT
108 RESOURCE MAPPING UNIT
109 IDFT UNIT
110 GI INSERTION UNIT
111 TRANSMISSION UNIT
112 TRANSMISSION ANTENNA UNIT
121 RECEPTION ANTENNA UNIT
122 RECEPTION UNIT
123 CONTROL SIGNAL DETECTION UNIT
151 HIGHER LAYER
154 PRE-CODING UNIT
157 CONTROL SIGNAL GENERATION UNIT
200 MOBILE STATION DEVICE
201 RECEPTION ANTENNA UNIT
202 RECEPTION UNIT
203 A/D UNIT
204 GI REMOVING UNIT
205 DFT UNIT
206 CHANNEL ESTIMATION UNIT
207 INTERFERENCE SUPPRESSION UNIT
208 FEEDBACK INFORMATION GENERATION UNIT
209 CHANNEL COMPENSATION UNIT
210 DEMODULATION UNIT
211 DECODING UNIT
212 CONTROL SIGNAL DETECTION UNIT
213 HIGHER LAYER
221 CONTROL SIGNAL GENERATION UNIT
222 TRANSMISSION UNIT
223 TRANSMISSION ANTENNA UNIT

1-14. (canceled)

15. A mobile station device in a communication system which includes a plurality of base station devices and the mobile station device connected to at least one of the plurality of base station devices, the mobile station device comprising:
a feedback information generation unit that generates feedback information for transmitting channel information between the base station device connected to the mobile station device and the mobile station device and feedback information for transmitting channel information between a base station device other than the base station connected to the mobile station device and the mobile station device, and
a transmission unit that transmits the feedback information to the base station devices,
wherein the feedback information generation unit generates the feedback information by quantizing the channel information, and
wherein the number of bits of the feedback information for transmitting the channel information between the mobile station device and the base station device connected to the mobile station device and the number of bits of the feedback information for transmitting the channel information between the mobile station device and the base station device other than the base station connected to the mobile station device, which are generated in the feedback information generation unit, are different.

16. The mobile station device according to claim 15,
wherein in the feedback information generation unit, the number of bits of the feedback information for transmitting channel information between the base station device connected to the mobile station device and the mobile station device is smaller than the number of bits of the feedback information for transmitting channel information between the base station device other than the base station connected to the mobile station device and the mobile station device are different.

17. The mobile station device according to claim 15,
wherein the feedback information generation unit generates the feedback information, by compressing the channel, and
wherein a compression rate of the feedback information for transmitting channel information between the base station device connected to the mobile station device and the mobile station device and a compression rate of the feedback information for transmitting channel information between the base station device other than the base station connected to the mobile station device and the mobile station device are different.

18. The mobile station device according to claim 17,
wherein in the feedback information generation unit, the compression rate of the feedback information for transmitting channel information between the base station device connected to the mobile station device and the mobile station device is greater than the compression rate of the feedback information for transmitting channel information between the base station device other than the base station connected to the mobile station device and the mobile station device.

19. The mobile station device according to claim 15, further comprising:
a control signal generation unit that generates an uplink control signal,
wherein the transmission unit transmits the uplink control signal to the base station device, and
wherein the control signal generation unit has a control signal format for the control signal containing the feedback information.

20. The mobile station device according to claim 15, further comprising:
a control signal generation unit that generates an uplink control signal,
wherein the transmission unit transmits the uplink control signal to the base station device, and
wherein the control signal generation unit has a control signal format containing the feedback information indicating the channel information between the base station device connected to the mobile station device and the mobile station device and a control signal format containing the feedback information indicating the channel information between the base station device other than the base station connected to the mobile station device and the mobile station device.

21. The mobile station device according to claim 20,
wherein the control signal format containing the feedback information indicating the channel information between the base station device connected to the mobile station device and the mobile station device and the control signal format containing the feedback information indicating the channel information between the base station device other than the base station connected to the mobile station device and the mobile station device are control signal formats having different numbers of OFDM symbols.

22. The mobile station device according to claim 20,
wherein the control signal format containing the feedback information indicating the channel information between the base station device connected to the mobile station device and the mobile station device and the control signal format containing the feedback information indicating the channel information between the base station device other than the base station connected to the mobile station device and the mobile station device are control signal formats having different numbers of subcarriers.

23. A base station device in a communication system which includes a plurality of base station devices and a mobile station device connected to at least one of the plurality of base station devices a certain base station device of the plurality of base station devices, comprising:
a reception unit that receives feedback information for transmitting channel information between the mobile station device connected to the base station device and the base station device and feedback information for transmitting channel information between the mobile station device and a base station device other than the base station connected to the mobile station device, from the mobile station device; and
a weight coefficient calculation unit that calculates a transmission weight coefficient to be multiplied by transmission data which is transmitted from each base station device to the mobile station device connected to the base station device, by using the feedback information,
wherein the plurality of base station devices each includes a pre-coding unit that multiplies the transmission data by the transmission weight coefficient, and
wherein the amount of the feedback information for notifying the channel information between the mobile station device and the base station device connected to the mobile station device and the amount of the feedback information for notifying the channel information between the mobile station device and the base station device other than the base station connected to the mobile station device are different.

24. A transmission method of a mobile station device in a communication system which includes a plurality of base station devices and the mobile station device connected to at least one of the plurality of base station devices,
wherein the mobile station device performs
a feedback information generation procedure of generating feedback information for transmitting channel information between the base station device connected to the mobile station device and the mobile station device and feedback information for transmitting channel information between a base station device other than the base station connected to the mobile station device and the mobile station device, and
a transmission procedure of transmitting the feedback information to the base station devices,
wherein in the feedback information generation procedure, the feedback information is generated by quantizing the channel information, and
wherein the number of bits of the feedback information for transmitting channel information between the base station device connected to the mobile station device and the mobile station device, and the number of bits of the feedback information for transmitting channel information between the base station device other than the base station connected to the mobile station device and the mobile station device are different.
